(19) United States
(12) Patent Application Publication
(10) Pub. No.: US 2025/0352302 A1
(43) Pub. Date: Nov. 20, 2025

(54) OPTIMIZED PATIENT-SPECIFIC DENTAL APPLIANCE DESIGN

(71) Applicant: ALIGN TECHNOLOGY, INC., San Jose, CA (US)

(72) Inventors: Xirui PENG, Apex, NC (US); Yuxiang WANG, Newark, CA (US); Jeffrey McGUIRE, Raleigh, NC (US); Jun SATO, San Jose, CA (US)

(73) Assignee: ALIGN TECHNOLOGY, INC., San Jose, CA (US)

(21) Appl. No.: 19/212,011

(22) Filed: May 19, 2025

Related U.S. Application Data
(60) Provisional application No. 63/649,831, filed on May 20, 2024.

(51) Int. Cl. A61C 7/00; A61C 13/34

(52) U.S. Cl. CPC A61C 7/002; A61C 13/34

(57) ABSTRACT

Systems, apparatuses, and methods for iteratively optimizing a dental appliance geometry based on simulated changes to dental appliance parameters and resulting effects of the dental appliance when applied to a patient's oral cavity.

### BACKGROUND

This application claims the benefit under 35 U.S.C. § 119(e) of U.S. Provisional Patent Application No. 63/649,831, filed May 20, 2024, which is incorporated, in its entirety, by this reference.

Orthodontic and dental treatments using a series of patient-removable appliances, such as orthodontic aligners, palatal expanders, auxiliaries (e.g., attachments, buttons, power arms), and auxiliary positioners are very useful for treating patients, particularly for dental malocclusions. Treatment planning is typically performed in conjunction with the dental professional (e.g., dentist, orthodontist, dental technician, etc.), by generating a model of the patient's teeth and/or jaw in a final configuration and then dividing the treatment into a number of stages (steps) corresponding to individual appliances that are worn sequentially. This process may be interactive, adjusting the staging and in some cases the final target position, based on constraints on the movement of the teeth and the dental professional's preferences. Once the final treatment plan is finalized, the series of orthodontic aligners and other orthodontic appliances may be manufactured for each of the stages of the treatment plan.

Various orthodontic appliances may be used to treat dental conditions. For example, a palatal expander may be used to slowly expand the roof of the mouth and widen the upper jaw to address conditions such as crossbites or tooth crowding. Palatal expanders are often customized per-subject and per-stage. However, the customization may be limited, which may lead to less than ideal treatment and treatment outcomes. For example, a palatal expander may impart an expansion force that is too large or small for different subject morphologies. In some treatments, the distribution of the expansion force may not be uniform. Such issues may arise due to, for instance, the designs failing to properly account for differences between patients, e.g., for subjects with deeper or shallower palate, wider or narrower arch, different tooth arrangements, and also when the subject morphology changes during treatment.

The methods and apparatuses described herein may improve appliance designs, including increasing the speed at which appliance designs may be optimized, as well as providing greater control to the dental professional, and allowing improved subject experience with the appliance, such as by providing a more accurate and uniformly distributed expansion force. Other aspects of dental treatment may also be improved through the use of the systems and methods describe herein with respect to other dental appliances, such as more accurate force generation imparted by aligners on auxiliaries, more predictable and acceptable insertion and removal forces when applying and removing appliances, and auxiliary positioner usability may be improved through more accurate and optimized placement of supports. Subject comfort may be improved by the methods and apparatuses described herein.

### SUMMARY

Systems, apparatuses, and methods are directed to systems, methods, and apparatuses for iteratively optimizing a dental appliance geometry based on the simulated changes to dental appliance parameters and the resulting effects of the dental appliance when applied to a patient's oral cavity.

For example, a method of designing a personalized dental appliance may include receiving a digital anatomical model of an intraoral cavity of a subject and selecting a test parameter set for a test dental appliance. The test parameter set may define one or more design parameters of the test dental appliance. The method may also include performing an optimization process for identifying a final design parameter set. The optimization process may include initializing a surrogate model representing an uncertainty distribution of design parameters and values associated with effects corresponding to the design parameters, simulating, using an evaluator, one or more effects of the test dental appliance based on the test parameter set, determining whether the simulated effects satisfy one or more predetermined criteria for the personalized dental appliance, updating the surrogate model based on the simulated effects, and selecting, with an optimizer, a subsequent test parameter set. The method may also include determining, based on the optimization process, the final design parameter set and generating a digital model of the dental appliance based on the final design parameter set.

In one embodiment, the disclosure is directed to a non-transitory computer readable medium containing a set of computer-executable instructions, wherein when the set of instructions are executed by one or more electronic processors or co-processors, the processors or co-processors (or a device of which they are part) perform a set of operations that implement an embodiment of the disclosed method or methods.

In some embodiments, the systems and methods disclosed herein may provide services through a SaaS or multi-tenant platform. The platform provides access to multiple entities, each with a separate account and associated data storage. Each account may correspond to a dentist or orthodontist, a patient, an entity, a set or category of entities, a set or category of patients, an insurance company, or an organization, for example. Each account may access one or more services, a set of which are instantiated in their account, and which implement one or more of the methods or functions disclosed and/or described herein.

Other objects and advantages of the systems, apparatuses, and methods disclosed will be apparent to one of ordinary skill in the art upon review of the detailed description and the included figures. Throughout the drawings, identical reference characters and descriptions indicate similar, but not necessarily identical, elements. While the embodiments disclosed or described herein are susceptible to various modifications and alternative forms, specific embodiments are shown by way of example in the drawings and are described in detail herein. However, embodiments of the disclosure are not limited to the exemplary or specific forms described. Rather, the disclosure covers all modifications, equivalents, and alternatives falling within the scope of the appended claims.

The terms “invention,” “the invention,” “this invention,” “the present invention,” “the present disclosure,” or “the disclosure” as used herein are intended to refer broadly to all the subject matter disclosed in this document, the drawings or figures, and to the claims. Statements containing these terms do not limit the subject matter disclosed or the meaning or scope of the claims. Embodiments covered by this disclosure are defined by the claims and not by this summary. This summary is a high-level overview of various aspects of the disclosure and introduces some of the concepts that are further described in the Detailed

Description section below. This summary is not intended to identify key, essential or required features of the claimed subject matter, nor is it intended to be used in isolation to determine the scope of the claimed subject matter. The subject matter should be understood by reference to appropriate portions of the entire specification, to any or all figures or drawings, and to each claim.

### BRIEF DESCRIPTION OF THE DRAWINGS

Embodiments of the disclosure are described with reference to the drawings, in which:

FIG. 1 is a flowchart or flow diagram illustrating a process, method, operation, or function that may be performed, in accordance with some embodiments described herein;

FIG. 2 depicts an upper arch of a subject with a palatal expander, in accordance with some embodiments described herein;

FIG. 3 depicts a band of a palatal expander from a top and side view, in accordance with some embodiments described herein;

FIGS. 4A, 4B, and 4C depict charts of steps in a process, method, operation, or function for designing a dental appliance, in accordance with some embodiments described herein;

FIGS. 5A, 5B, and 5C depict aspects of a palatal expander that may be determined specifically for each patient, in accordance with some embodiments described herein;

FIG. 5D illustrates a palatal expander design that may have been optimized to provide target forces across its three bands, but without considering thickness uniformity.

FIG. 5E illustrates a revised palatal expander design that optimizes for both thickness uniformity and force targets.

FIG. 6 depicts an auxiliary positioner designed according to the methods, processes, functions, or operations, in accordance with some embodiments described herein;

FIG. 7 is a diagram illustrating elements or components that may be present in a computer device or system configured to implement a method, process, function, or operation, in accordance with some embodiments described herein;

FIGS. 8, 9, and 10 are diagrams illustrating an architecture for a multi-tenant or SaaS platform that may be used in implementing an embodiment of the systems and methods disclosed herein; and

FIG. 11 depicts a simplified block diagram of a data processing system, in accordance with some embodiments described herein.

Note that the same numbers are used throughout the disclosure and figures to reference like components and features.

### DETAILED DESCRIPTION

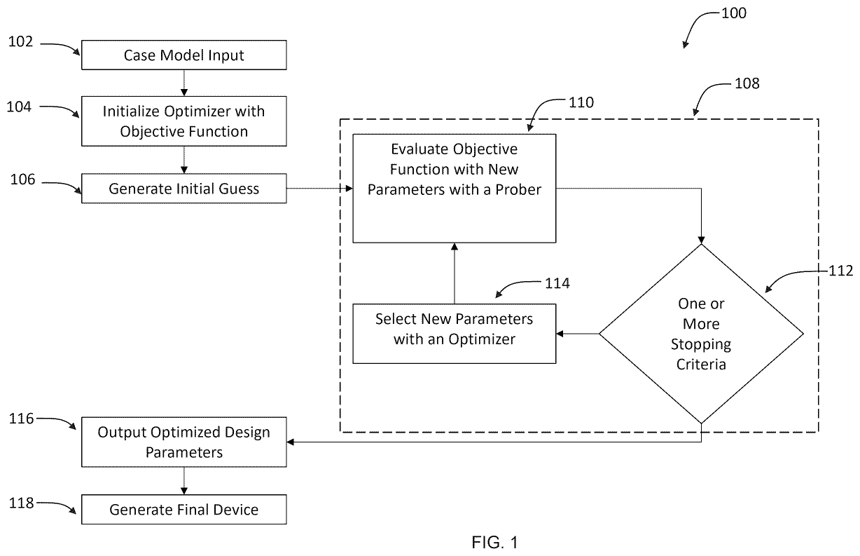

FIG. 1 is a diagram illustrating a set of processes, methods, operations, or functions 100 that may be performed in an implementation of an embodiment of the disclosed system and methods. As shown in the figure, an embodiment may comprise one or more of the following steps or stages. Embodiments disclosed herein may be used to optimize the design of dental appliances for use in a subject. As used herein, the term “dental appliance” includes palatal expanders, aligners, retainers, mouthguards, brackets and wires, tooth-mounted sensor devices, or any other appliance that is configured to be worn in a subject's mouth for treatment, monitoring, and/or preventative purposes.

At block 102 the method may include input of a case model. The case model may include a digital model of the anatomy of the oral cavity of the patient, including their hard and soft tissues, such as teeth, palate, and gums. The case model may be generated using a dental scanning system which may include an input device as described herein and may include a computer system configured to capture one or more scans of a patient's dentition. The scan engine may capture 2D and/or 3D images of a patient. Such images may include images of the patient's teeth, face, and jaw, for example. The images may also include x-rays, computed tomography, magnetic resonance imaging (MRI), cone beam computed tomography (CBCT), cephalogram images, panoramic x-ray images, digital imaging and communication in medicine (DICOM) images, or other subsurface images of the patient. The scan engine may also capture 3D data representing the patient's teeth, face, gingiva, or other aspects of the patient.

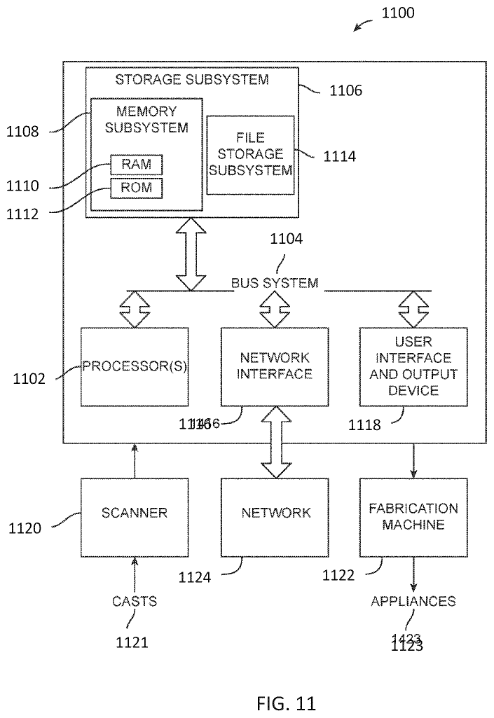

A dental scanning system may also include a 2D imaging system, such as a still camera and/or a video camera, an x-ray machine, or other 2D imager. In some embodiments, dental scanning system may also include a 3D imager, such as an intraoral scanner, an impression scanner, a tomography system, a cone beam computed tomography (CBCT) system, or other system as described herein, for example. A dental scanning system 1120, see FIG. 11, and associated engines and imagers that can be used to capture the 2D and 3D images of a patient's face and dentition for use in building a 3D parametric model of the patient's teeth as described herein. The dental scanning system may generate cephalogram images, panoramic x-ray images, digital imaging and communication in medicine (DICOM) images, or other subsurface images of the patient. The dental scanning system may generate a 3D model surface model of the surfaces of the patient's face and dentition, such as 3D surface models.

The scan data generated using the dental scanning system may be used in a treatment planning process to generate a treatment plan for treating a dental malocclusion of the patient.

The case model may include a dental treatment plan or one or more stages of a dental treatment plan. A dental treatment planning system may be used to generate a dental treatment plan, such as by using a treatment planning module, as described herein. A dental treatment planning system may include a computer system configured to determine the stages of and generate an orthodontic treatment plan for moving a patient's teeth or other oral anatomy from an initial position, for example, based in part on the scan data of the patient's intraoral cavity, to a final position through a series of incremental movement stages. For an orthodontic treatment, the stages may move the teeth from an initial arrangement towards a desired final arrangement. For a palatal expansion treatment, the stages may widen the palate (and in doing so, also move the patient's teeth) from an initial configuration towards a final desired configuration. The dental treatment planning system may be operative to provide for image viewing on a display device and in some cases, manipulation, such that rendered images may be scrollable, pivotable, zoomable, and interactive. The dental treatment planning system may include graphics rendering hardware, one or more displays, and one or more input devices. Some or all of dental treatment planning system may be implemented on a personal computing device such as a desktop computing device or a handheld device, such as a mobile phone. In some embodiments, at least a portion of dental treatment planning system may be implemented on a scanning system, such as dental scanning system.

For each stage of a dental treatment, a 3D digital model of one or more portions of the patient's intraoral cavity may be generated with the patient's anatomy in a position for that stage of treatment. Such 3D digital model may be part of the case model. The 3D digital model may also include other anatomy that affects or is related to dental function. For example, the 3D digital model may include a model of the bones and joints used in articulation, such as the jawbone and the TMJ. Bone and TMJ models may be generated using one or more of the imaging systems discussed herein, such as x-rays, computed tomography, magnetic resonance imaging (MRI), cone beam computed tomography (CBCT), cephalogram images, panoramic x-ray images, digital imaging and communication in medicine (DICOM) images, or other subsurface images of the patient. In some embodiments, the 3D digital model may include articulation information that describes how the jaw moves, such as the location and geometry of the TMJ and/or the jaw bone.

In some embodiments, other subsurface information and/or models may be part of the 3D digital model of the patient's intraoral cavity, such as the shape and location of the roots of the tooth which may also be gathered using the subsurface imaging techniques discussed herein.

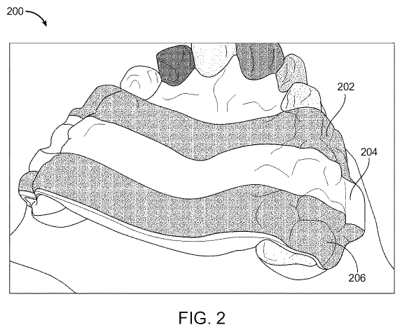

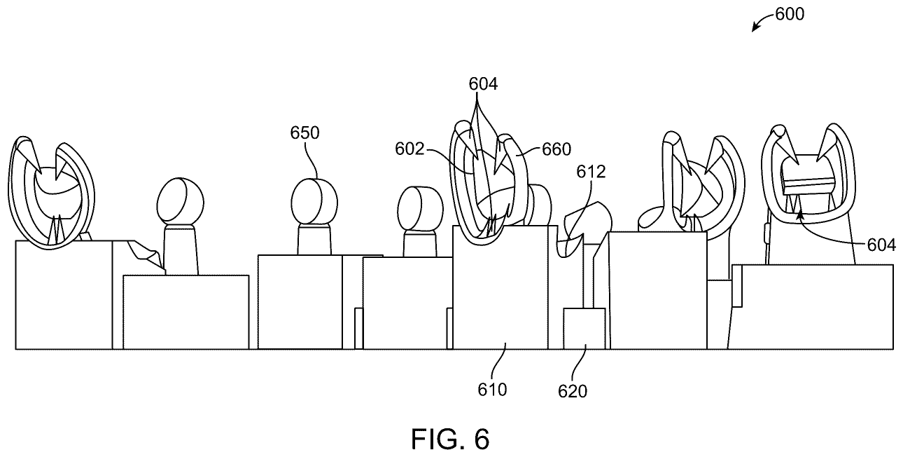

In some embodiments, the case model may also include a model of a dental appliance for one or more stages of treatment in the treatment plan. For example, FIG. 2 depicts a dental appliance, such as a palatal expander and FIG. 6 depicts a dental appliance, such as an auxiliary positioner and auxiliaries. As used herein, an auxiliary is a structure that is coupled (e.g., bonded or otherwise secured) to a surface of a tooth to engage a corresponding portion of a dental appliance, and may include, for example, an attachment, button, bracket, power arm, etc. Other dental appliances may also be included in the case model, such as orthodontic aligners, retainers, etc. In some embodiments, the case model input may also include one or more parameters of the appliance.

The parameters of the appliance may include the type of material used to form the appliance (e.g., a styrenic block copolymer (SBC), a silicone rubber, an elastomeric alloy, a thermoplastic elastomer (TPE), a thermoplastic vulcanizate (TPV) elastomer, a polyurethane elastomer, a block copolymer elastomer, a polyolefin blend elastomer, a thermoplastic co-polyester elastomer, a thermoplastic polyimide elastomer, a polyester, a co-polyester, a polycarbonate, a thermoplastic polyurethane, a polypropylene, a polyethylene, a polypropylene and polyethylene copolymer, an acrylic, a polyetheretherketone, a polyamide, a polyethylene terephthalate, a polybutylene terephthalate, a polyetherimide, a polyethersulfone, a polytrimethylene terephthalate or a combination thereof (e.g., a blend of at least two of the listed soft polymeric materials). In some embodiments, the appliance may be a multimaterial and/or multi-layered appliance. The material parameters may include the blend or alloy and/or material parameters for each of the layers (e.g., material type, thickness, arrangements of the layers, etc.).

In some embodiments, the parameters may include the material properties of the appliance, such as density, bulk modulus, elasticity, Young's modulus, Poison's ratio, shear modulus, shear strength, etc. In some embodiments, the parameters of the appliance may include geometric parameters, such as dimensions, including thicknesses and lengths, shapes, etc. In some embodiments, the parameters of the dental appliance may be initial design parameters. For example, an initial design of a dental appliance may include non-personalized parameters (e.g., shape, thicknesses) for the geometry.

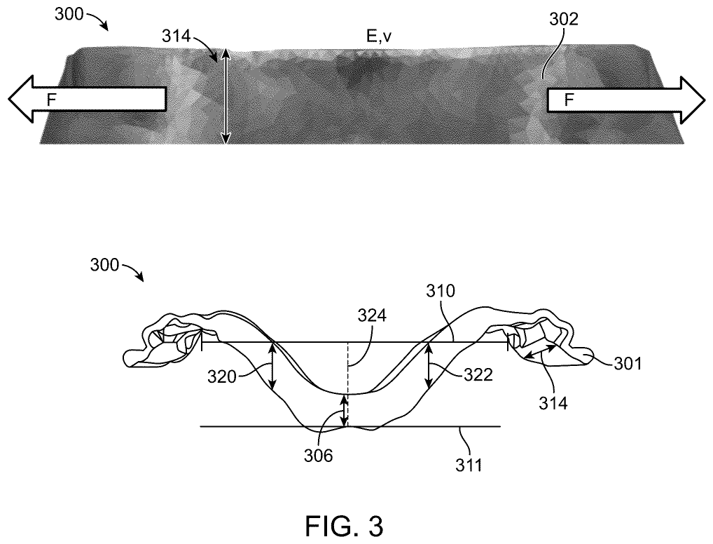

At block 104, an optimizer may be initialized with an objective function. For example, in some embodiments, a Bayesian optimization algorithm may be used. In such embodiments, the algorithm is initialized with an objective function that quantifies how well the dental appliance meets the desired specifications. In some examples, a palatal expander may be designed with bands (e.g., three bands as shown in FIG. 2) that laterally traverse the palatal expander from a left side to a right side when worn by a patient. In these examples, the desired specifications may specify the total amount of expansion force imparted on the patent's teeth and/or the amount of expansion force imparted by each of the palatal expander bands, such as described below with respect to FIGS. 2 and 3. For example, a desired total expansion force may be 60 N (Newtons) with each of the three bands contributing 20 N.

In some embodiments, the objective function may be directed to other desired specifications or functionality. For example, with a palatal expander and an orthodontic aligner, insertion, retention, and removal force may be a design consideration. In some embodiments, the shape of the dental appliance at locations where the dental appliance interfaces with the patient's dentition, such as in tooth receiving cavity, may be modified or optimized to design and fabricate the dental appliance with sufficient ability to be retained on the patient's dentition while still allowing for easy insertion and removal of the appliance from the patient's teeth by the patient. In some embodiments, parameters that may have an effect on insertion, removal, and retention may include the thickness of the appliance at the tooth receiving cavity or near a tooth receiving portion of the appliance, and how closely the appliance fits the patient's anatomy such as the teeth when worn. For example, a parameter that defines the gap or distance between a tooth receiving cavity or other tooth engaging structure and the tooth may change the insertion force, removal force, and retention force.

A tooth receiving cavity may be a cavity in a dental appliance that is shaped to receive a tooth therein. A tooth receiving cavity may be shaped to fit closely over the tooth received therein and may be based on a 3D surface scan of the patient's teeth. For example, the contours of the internal surface of a tooth receiving may closely match or correspond to the external surface of the crown of the tooth received therein. For orthodontic aligners, the position of the tooth receiving cavity may be displaced (e.g., translated and/or rotated) from the position of the tooth in the 3D scan in order to exert an orthodontic movement force on the tooth. In some embodiments, the tooth receiving cavity may include protrusions that protrude inward towards a tooth crown when the tooth is received within the cavity in order to impart forces on the tooth.

A palatal expander may include two sets or of tooth receiving cavities, a left set that is shaped to receive teeth on a left side of the patient's arch and a right set that is shaped to receive teeth on the right side of the patient's arch. A palatal region may be located and extend between the left and right sets of tooth receiving cavities. The palatal region, in cooperation with the tooth receiving cavities, impart a palatal expansion force on the patient's anatomy, such as on the tooth crowns, through the tooth roots, and into the palate to expand the palate.

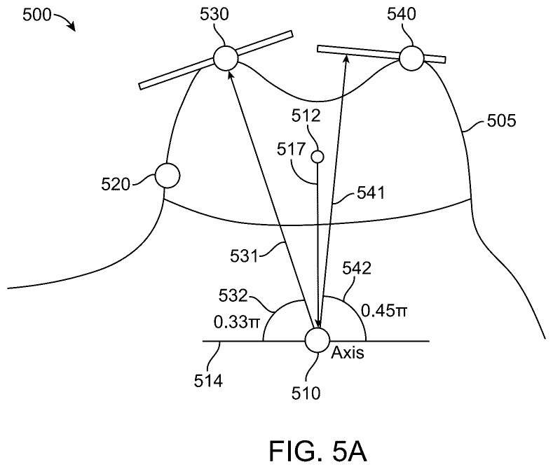

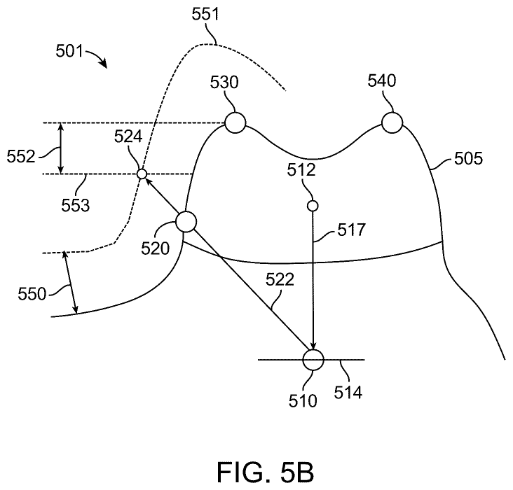

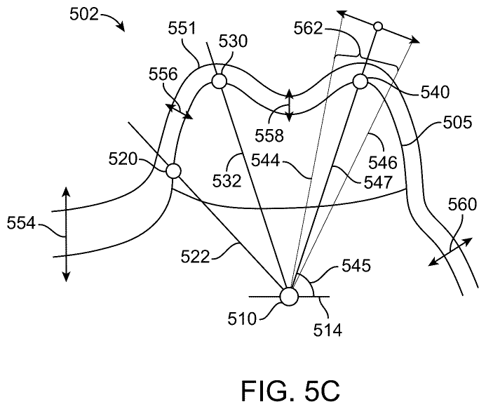

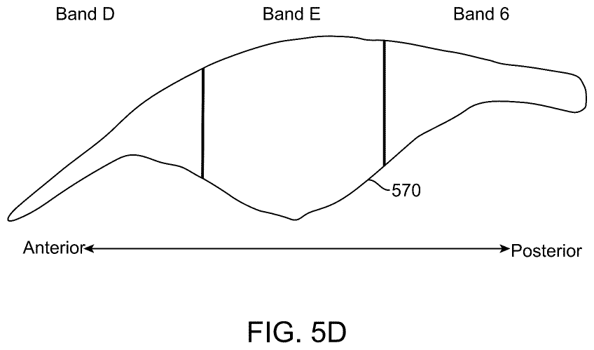

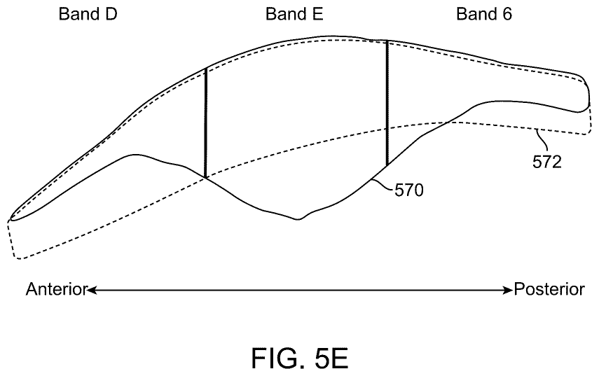

In some embodiments, parameters related to the size, shape, location, surface angle, and other features of an auxiliary (e.g., attachment, button) may be optimized for insertion force, retention force, and removal force. FIGS. 3 and 5A-5C depict aspects of the shape of palatal expanders and tooth engagement structures that may play a role in insertion forces, retention forces, and removal forces.

In some embodiments, the shape and structure of a dental appliance may be designed for fabrication and use. For example, an auxiliary positioner 600, such as shown and described with respect to FIG. 6 may include an auxiliary frame 660 and one or more struts 604 that hold an auxiliary (e.g., an attachment, button, power arm) in place during fabrication and then should be easily separated from the auxiliary 602 after the auxiliary 602 has been placed on a patient's dentition. Parameters for designing an auxiliary frame and the struts for holding the auxiliary may include parameters for the geometry of the struts and their location. For example, the parameters may include the number of struts 604, their location such as their angular location about the auxiliary, the length of the struts 604, the diameter of the strut or parameters related to the cross-sectional area of the strut where the strut contacts the auxiliary. The parameters may also include the thickness of the frame 660 and a distance of the frame from the auxiliary, and other geometric parameters.

In some embodiments, optimization for fabrication may also include optimizing the geometry to control deflection of the device and layer adhesion during fabrication. For example, the placement and geometry of the device may be manipulated during optimization to control anticipated deflection during fabrication or one or more layers to within a range and below a threshold. Layer adhesion may be controlled based on, for example, the rate of change of cross-sectional area from layer to layer during fabrication.

At block 106 one or more initial test parameters, such as a test parameter set, are

selected. In some embodiments, the initial parameters may be default values such as a default thickness of each of the three bands of a palatal expander, a default number of struts connecting each auxiliary to an auxiliary frame, or other parameters, which may depend on the type of dental appliance being generated.

In some embodiments, the values for the initial parameters may be determined based on a preestablished relationship within a lookup table or database. For example, the initial parameters for the thicknesses of the bands of a palatal expander may be related to the depth of a patient's palate. In such embodiments, a lookup table may provide initial thicknesses for the bands of a palatal expander based on the depth of a patient's palate. In some embodiments the initial parameters for the number of struts and/or the location of struts may be determined from a table based on the size, shape, location or other aspects of the auxiliary and its location on the patient's teeth. The initial parameters should be within the design space of the dental appliance. For example, in a palatal expander the thickness of the palatal expander for the initial parameters should be within a range of thicknesses suitable for a palatal expander such as between 0.25 mm and 10 mm. Thicknesses that are unrealistic for use in a palatal expander may be excluded from the design space. The parameters may also include a stopping criterion such as the total number of iterations to be performed by the optimization loop 108 before stopping, an acceptable value or values for the results of the evaluation of the objective function such as a desired total expansion force and a force for each of the bands of a palatal expander (e.g., one band, two bands, three bands, etc.). In some embodiments, stopping criterion may include an acceptable deformation during fabrication of an auxiliary positioner. In some embodiments, stopping criterion may include reaching a desired insertion, removal, and/or retention force of an appliance. In some embodiments, a stopping criterion may be a range of values or an acceptable deviation from the desired values. In some embodiments, a loss function which may be a function of the difference between the evaluated results and the desired results may be used in determining whether the stopping criterion has been met. In some embodiments, such as where multiple results are evaluated, weights may be assigned to each of the results and their associated loss function in determining whether the stopping criterion is met. For example, in some embodiments the total expansion force may be given a greater weight than the expansion force for each of the individual bands. In such an example, a stopping criterion may be met when the results of the evaluation show relatively larger deviations from the desired expansion force for the individual bands while the total force closely matches the desired total expansion force.

In some embodiments, the initial parameters may be generated based on a machine learning model. In some embodiments, the inputs to the machine learning model may include a model of the patient's anatomy, such as a model of the patient's teeth of the upper and/or lower arches, target forces, and the material properties of the dental appliance. In some embodiments, a machine learning model such as that described in U.S. patent application Ser. No. 17/823,835, titled “Patient Specific Appliance Design,” filed Aug. 31, 2022, is herein incorporated by reference in its entirety, may be used to generate an initial guess for the parameters of the dental appliance. In some embodiments, the machine learning model may be trained from a large group of case parameters such as models of the patient's anatomy, target forces, and material properties of a dental appliance that have been tested against associated finite element analysis (FEA) results. During use, the machine learning model may receive case parameters for a particular subject and output thicknesses for the bands of a palatal expander.

In some embodiments, a machine learning model may be trained to output forces of an appliance based on input parameters. Training such a machine learning model may include gathering data related to previous treatments into a database of previously designed and/or successfully used dental appliance. For reach previously designed and/or successfully used dental appliance, the database may include a 3-D digital model of the patient's maxillary and/or mandibular dentition and palate, the relevant elastic-plastic properties of the appliance material, a thickness map, and the resulting forces of the appliance applied to the patient's palate, such as through a finite-element analysis (FEA), physical testing of an appliance fabricated using the thicknesses for each band, or clinical follow-up. In some embodiments, the data may include annotated images, such as images with associated meta-data that describe the parameters of the appliance, patient anatomy, and/or the resulting or forces. The model is then trained based on the database to output appliances forces for appliance bands. The training includes comparing the output of the machine learning model to the known good thicknesses and other parameters and resulting forces by favoring outputs that are closer to the know good forces and disfavoring outputs that are further from the know good forces. After training, a new patient's scanned anatomy, appliance parameters, and material parameters are input into the model, the network produces expected forces applied by the appliance. Several test parameters may be input into the machine learning model and the parameters that produce forces for a band, set of bands, or appliance, closes to the desired forces for a patient may be used as a starting point for determining parameters for a finalized dental appliance, such as a palatal expander.

Training a machine learning model that outputs reasonable initial test parameters for a dental appliance may include gathering data related to previous treatments into a database of previously designed and/or successfully used dental appliance. For reach previously designed and/or successfully used dental appliance, the database may include a 3-D digital model of the patient's maxillary and/or mandibular dentition and palate, the clinically prescribed force system for expansion (e.g., magnitude and direction vectors at selected anchor points), the relevant elastic-plastic properties of the appliance material, and the thickness map that met those force goals, such as through a finite-element analysis (FEA), physical testing of an appliance fabricated using the thicknesses for each band, or clinical follow-up. In some embodiments, the data may include annotated images, such as images with associated meta-data that describe the parameters of the appliance, patient anatomy, and/or the resulting or prescribed forces. The model is then trained based on the database to output thicknesses for appliance bands and other parameters. The training includes comparing the output of the machine learning model to the known good thicknesses and other parameters and resulting forces by favoring outputs that are closer to the know good thickness and other parameters and disfavoring outputs that are further from the know good thickness. After training, a new patient's scanned anatomy, desired forces, and material parameters are input into the model, the network produces initial thickness and other parameter recommendations that serve as a starting point for determining parameters for a finalized dental appliance, such as a palatal expander.

At block 108 the optimization loop for designing the dental appliance receives the initial parameters and carries out the steps of testing the parameters, checking the results of the test against one or more stopping criteria, modifying the parameters based on the results of the test, and iterating through the optimization loop until the stopping criterion is met. The optimization loop may include evaluating an objective function with a set of parameters using a probe at block 110, determining whether the results of the evaluation of the objective function with the parameters meet one or more stopping criteria at block 112, and, if the one or more stopping criteria are not met, selecting new parameters using an optimizer at block 114. The new parameters may be used in a second or subsequent iteration of the loop at block 110. The optimization loop may be iteratively performed until stopping criterion is met.

At block 110 the objective function is evaluated with the parameters using a probe. During the first iteration of the loop 108, the parameters may be the initial parameters as determined at block 106. In subsequent iterations through the loop 108 the parameters may be the parameters selected at block 114, as discussed herein.

In some embodiments, the loop 108 may be a Bayesian optimization loop, and the objective function may be evaluated using a finite element analysis (FEA) simulation that predicts a dental appliance's performance using the parameters as input. The FEA simulation may include aspects of the case model input such as the geometry of the patient's dental structures including the teeth (such as the crown and roots), palate, the gingiva, and other hard and soft tissues of the patient's intraoral cavity. The FEA simulation may also include the appliance design, such as that received in the case model input step at block 102, and may be modified based on the parameters received from block 106.

The FEA simulation may predict the dental appliance's performance based on one or more boundary conditions. The boundary conditions may define the interaction between the dental appliance and the patient's dental anatomy.

The objective function may compute a loss by considering one or more targets for the dental appliance's performance. The loss being, for example, a deviation of the evaluated result from the desired result.

For a palatal expander, the targets may include, for example, a total force target and one or more individual force targets. The total force target may be the sum of the reaction forces on the palatal expander from each of the teeth as compared to a predetermined target for the total force. The individual force target may be the deviation between the reaction force values on each tooth and a target reaction force value. In some embodiments the target reaction force value for the force on each tooth may be the same. For example, a palatal expander individual force target may be 20 N on each pair of teeth for a subject whose anatomy allows for three pairs of teeth to be engaged by the palatal expander, and the palatal expander total force target in this example may add up to 60 N. In some embodiments, the target individual reaction force value for each tooth pair may vary. For example, a first tooth pair may receive 15 N of force, a second tooth pair may receive 25 N of force, and a third tooth pair may receive 20 N of force. As explained below, these target individual reaction forces may be achieved by adjusting design parameters (e.g., thicknesses) across bands of the palatal expander (e.g., a first band may correspond to the first tooth pair, a second band may correspond to the second tooth pair, and a third band may correspond to the third tooth pair. Although these targets may be held up as an ideal prior to the optimization process, they may not be required in the final optimized design.

In some embodiments, the targets may include achieving a relative uniformity in a dimension of a dental appliance. For example, it may be ideal for a palatal expander to have relative uniformity in thickness, because, e.g., it may be uncomfortable to wear a palatal expander that has widely varying thicknesses or abrupt changes in thickness. For example, FIG. 5D illustrates a palatal expander design 570 that may have been optimized to provide target forces across its three bands, but without considering thickness uniformity. As illustrated, in this example, the middle band E is significantly thicker than the anterior and posterior bands D and 6. This may be uncomfortable, and it may even restrict speech or tongue movement. The methods disclosed herein may include a thickness uniformity target such that a design such as the one in FIG. 5D is penalized for having excessive nonuniformity of thicknesses across the bands (or alternatively or additionally, rewarded for increased uniformity of such thicknesses). For example, the objective function may be caused to evaluate a lower loss value for such nonuniformity (or alternatively or additionally, a higher loss value for uniformity). Adding a thickness uniformity target to the optimization method may result in a revised optimal design that is more uniform. For example, FIG. 5E illustrates a revised palatal expander design 572 that optimizes for both thickness uniformity and force targets.

In some embodiments other targets may be used, such as those directed to other desired specifications or functionality. For example, with a palatal expander and an orthodontic aligner, insertion, retention, and removal forces may be targets. In some embodiments, targets may include the insertion, removal, and retention forces of the appliance at the tooth receiving cavity or near a tooth receiving portion of the appliance. For example, a parameter that defines the gap or distance between a tooth receiving cavity or other tooth engaging structure and the tooth may change the insertion force, removal force, and retention force. In some embodiments, parameters related to the size, shape, location, surface angle, and other features of a dental auxiliary may be optimized for insertion force, retention force, and removal force. FIGS. 3 and 5A-5C depict aspects of the shape of palatal expanders and tooth engagement structures that may play a role in insertion forces, retention forces, and removal forces.

In some embodiments, the support structures of an auxiliary positioner, such as shown and described with respect to FIG. 6, may be optimized based on printability or mechanical support strength targets. For example, the number, location, size, and/or angle of the struts may be parameters of interest that are optimized using the optimization loop 108 to obtain the optimal design.

At block 112 the results of block 110 are checked against the one or more stopping criteria to determine if the optimization loop 108 should stop. In some embodiments, the one or more stopping criteria may be met when at least a single one of the one or more stopping criteria is met. In some embodiments, the one or more stopping criteria may include a maximum number of iterations permitted to be performed by the optimization loop 108 before stopping. For example, the one or more stopping criteria may be 30 iterations in which case after the loop 108 has been iterated through 30 times, then the one or more stopping criteria has been met and the process may proceed to block 116.

In some embodiments, the one or more stopping criteria may be an acceptable value or values for the results of the evaluation of the objective function. For example, in the case of a dental appliance, such as a palatal expander, the one or more stopping criteria may specify acceptable ranges for total expansion force and/or a force for each of the bands of a hypothetical palatal expander that is being tested. In some embodiments, a loss function, which may be a function of the difference between the evaluated results and the desired results, may be used in determining whether the one or more stopping criteria has been met. In some embodiments, such as where multiple results are evaluated, weights may be assigned to each of the results and their associated loss function in determining whether the one or more stopping criteria is met. For example, in the case of a palatal expander, in some embodiments the total expansion force may be given a greater weight than the expansion force for each of the individual bands. In such an example, a criteria of the one or more stopping criteria may be met when the results of the evaluation show relatively larger deviations from the desired expansion force for the individual bands while the total force closely matches the desired total expansion force. In some embodiments, a stop value V may be calculated for a hypothetical dental appliance, V=Ax₁+Bx₂+Cx₃+Dx₄+Ex₅, where x₁, x₂, x₃, x₄, and x₅ are four values corresponding to four criteria, and A, B, C, D, and E are respective weights. For example, in designing a palatal expander using the methods herein, x₁, x₂, and x₃ may correspond to individual expansion forces of each of three bands of a hypothetical palatal expander, x₄ may correspond to the total expansion force, and x₅ may correspond to a thickness uniformity metric. In this example, D may be higher than each of A, B, and C (or the combination of A, B, and C) such that the impact of the total expansion force on V is higher than the impact of the individual expansion forces on V. The methods and systems disclosed herein may determine that the one or more stopping criteria have been achieved when the stop value of V exceeds an acceptable value. In some embodiments, one or more stopping criteria may include an acceptable deformation during fabrication of an auxiliary positioner. In some embodiments, one or more stopping criteria may include reaching a desired insertion, removal, and/or retention force of an appliance. In some embodiments, one or more stopping criteria may include a range of values or an acceptable deviation from the desired values.

In some embodiments, other stopping criteria may be used. For example, in an orthodontic aligner, an acceptable force or range of force imparted by a tooth receiving cavity on a tooth for a stage of treatment may be used and/or an expected tooth displacement or displacement range of tooth displacement (e.g., translation or rotation) of a tooth for a stage of treatment may be used. In some embodiments, a retention force may be used as a stopping criteria, such as the retention force of a tooth receiving cavity on a tooth of the subject's detention.

As discussed above, a number of different stopping criteria may be used to optimize a dental appliance, and adjusting one or more parameters to optimize one or more associated stopping criteria may affect one or more other parameters and may as a result cause other one or more stopping criteria to be less optimal. For example, achieving more uniformity in thickness across two or more bands of a palatal expander may in some cases result in one or more force targets to be less optimized.

As another example, for an auxiliary, such as an attachment, similar stopping criteria may be used, such as an acceptable force or range of force imparted on a tooth by the interaction of an aligner on the attachment for a stage of treatment may be used and/or an expected tooth displacement or displacement range of tooth displacement (e.g., translation or rotation) of a tooth for a stage of treatment may be used. In some embodiments, a retention force may be used as a stopping criteria, such as the retention force of an attachment on an aligner.

If the one or more stopping criteria are not met, the process may proceed to block 114.

At block 114 one or more new parameters are guessed by an optimizer (e.g., an acquisition function) to be evaluated by the objective function (e.g., an FEA simulation) at block 110. A surrogate model (e.g., a Gaussian Process) that reflects current approximations of expected loss values and associated uncertainties of design parameters may be updated with the results from the objective function, refining the model for the next iteration of optimization. New design parameters, such as the thickness for each band of a palatal expander or other parameters as described herein for other dental appliances and auxiliaries, are selected by maximizing an acquisition function, which directs the search for the next point to evaluate. An acquisition function may be a heuristic based algorithm used to intelligently guess one of more design parameters for evaluation by an objective function (e.g., FEA simulation) to ultimately determine design parameters that yield an acceptable loss value (e.g., for a characteristic of a hypothetical dental appliance that is being designed). The acquisition function may explore the design space to determine which values to evaluate with an objective function for each parameter for each iteration of the loop 108. As explained below, the acquisition function may use strategies of exploitation and exploration in combination to intelligently guess values for evaluation by the objective function.

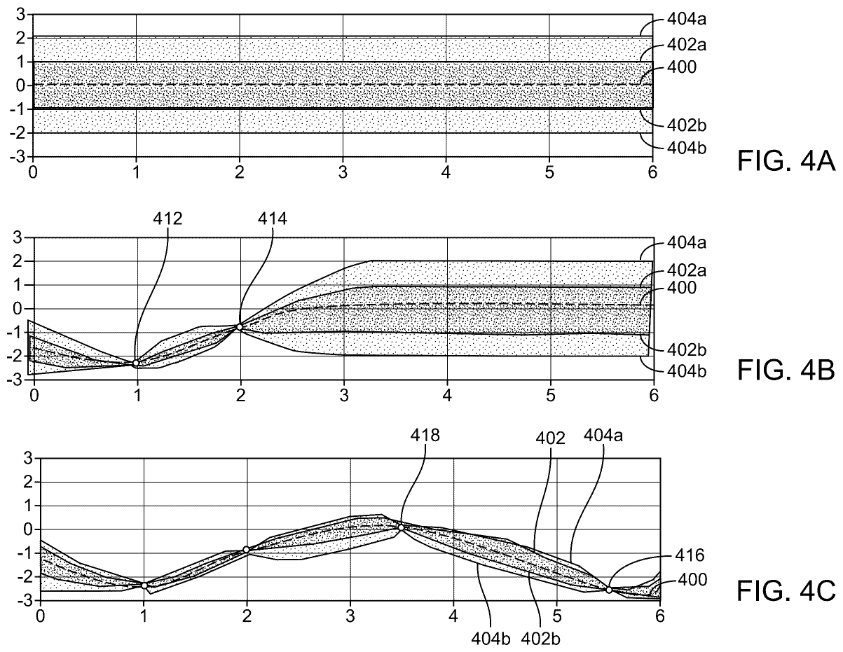

FIGS. 4A, 4B, and 4C, depict several iterations of an iterative training process of a surrogate model in an optimization loop (e.g., a Bayesian optimization loop), e.g., the optimization loop 108 discussed previously with respect to FIG. 1. While the optimization discussed herein includes multiple parameters and multiple evaluated results, FIGS. 4A, 4B, and 4C, depict a simplified optimization having a single parameter and the single evaluated results. For example, FIGS. 4A, 4B, and 4C, depict an iterative training process of a surrogate model (e.g., a Gaussian Process (GP) model) that charts predicted loss values (represented as −3 to 3 on the y-axis) for a continuous set of design parameters (e.g., represented as 0 to 6 on the x-axis). For example, these figures may depict the training of a surrogate model (e.g., a GP model) for predicting an optimal design parameter (e.g., a thickness, a shape), where the different values of the design parameter are represented by values along the x-axis and a predicted loss representing a deviation from a desired characteristic (e.g., an individual and/or overall expansion force) of the dental appliance is represented along the y-axis. As will be explained below, in some embodiments, the surrogate model is trained by an iterative process, where (1) an acquisition function “guesses” a design parameter (e.g., a thickness value for a band on a palatal expander), (2) an objective function (e.g., an FEA simulation) tests the design parameter by evaluating a loss (e.g., an individual and/or overall expansion force) for the design parameter, (3) the surrogate model and its corresponding uncertainty bounds are updated based on the evaluation, and (4) steps 1-3 are repeated until a parameter with an acceptable loss value (e.g., a thickness of a band of a palatal expander that achieves an expansionary force within an acceptable range) is found. With each iteration, more information is learned about how the parameters affect the loss value and the model is adjusted to account for this information. As explained elsewhere herein, the acquisition function references this updated model to make a further educated guess (trading between exploration and exploitation to make guesses that refine the model optimally).

At FIG. 4A, the graph depicts an initial state of the surrogate model 400 prior to evaluation of any guesses—i.e., prior to having gained any “knowledge” from evaluating parameters using an objective function. The surrogate model 400 may be thought of as an approximation of what might be the loss value for a given design parameter, based on information at a given time (as explained herein, this knowledge is updated by iteration by use of an objective function (e.g., FEA simulation) to evaluate selected design parameter values). In some embodiments, multiple sets of uncertainty bounds are calculated based on the surrogate model 400. For example, referencing FIGS. 4A-4C, low-confidence uncertainty bounds 402a, 402b and high-confidence uncertainty bounds 404a, 404b are calculated based on the surrogate model. For example, in FIG. 4A, there may be an 80% confidence that the loss value for a design parameter value (e.g., at x=1) is between −2 and 2, and there may be a 40% confidence that the loss value for that design parameter value is between 1 and −1.

As depicted in FIG. 4A, the surrogate model, upon initiation, has limited information about what loss values may be for any given design parameter. Accordingly, there is a relatively high uncertainty distribution 402, 404 throughout the entire parameter space. The uncertainty 402 may be one standard deviation of the loss and uncertainty 404 may be two standard deviations of the loss. Also as illustrated, the surrogate model in FIG. 4A has not yet been trained to intelligently distinguish among design parameter values 0 and 6, and the uncertainty distribution for all such values is the same. This is just for illustrative purposes—in some embodiments, the surrogate model 400 may have been generated with some initial information such that the initial surrogate model (and its uncertainty bounds) is not a zero-slope straight line, in which case it may have some ability to distinguish among different design parameter values.

The purpose of the optimization loop (e.g., a Bayesian optimization process) is to ultimately determine one or more design parameters that minimizes loss (e.g., determining a loss value that is within an acceptable range for a characteristic of a dental appliance). Upon repeated iteration, uncertainties in the model may be reduced as additional design parameter values are tested by an objective function (e.g., FEA simulation). In doing so, in some embodiments, the optimization loop may reduce the uncertainty (e.g., to as close to zero as possible or feasible) and thereby increase the confidence that the surrogate model 400 tends toward (e.g., closely matches at least one or more portions of) the objective function. FIG. 4B depicts the surrogate model and its uncertainty after two iterations. As illustrated, the acquisition function has made two guesses of the appliance design parameter values (e.g., a thickness of 1 and a thickness of 2) and an objective function has evaluated those parameter values to determine associated loss values (e.g., based on the simulated expansion force by the palatal expander for each of those parameter values). The first guess 412 and the second guess 414 have been evaluated and returned loss values of about −2 and about −1 respectively (e.g., based on simulated values of expansion forces). As illustrated, the model has been updated based on the loss values that were returned by the objective function. As discussed previously, this updating may be performed with each iteration.

The acquisition function is a function tasked with intelligently guessing design parameter values that are to be evaluated with the objective function, with a goal being to minimize the number of guesses necessary to reach an acceptable loss value. To determine what parameter values to guess, the acquisition function employs a guessing strategy that trades off exploitation (guessing parameter values where uncertainty is relatively low and where an improvement in loss value relative to known parameters can be expected with a fair degree of confidence) and exploration (guessing parameter values in areas of high uncertainty, e.g., areas that have not yet been explored well). This tradeoff may change over successive iterations. In some examples, the acquisition function may initially lean heavily toward exploitation (e.g., as it has little information to act on), and may increasingly favor exploration (e.g., as more information is gained, risks of exploration as lowered and the reward of additional information about a new area may be higher than the marginal reward of guessing an already explored area). The acquisition function may look at the current surrogate model (e.g., the surrogate model after two guesses depicted in FIG. 4B) to make a guess that optimizes exploitation and exploration strategies. For example, referencing FIG. 4B, the acquisition function may consider whether to guess in an area of low uncertainty (e.g., between x=1 and x=2), an area of high uncertainty (e.g., between x=3 and x=6), or some middle ground (e.g., between x=2 and x=3).

FIG. 4C shows the surrogate model 400 after two additional iterations. In an example, the acquisition function may have first selected point 416 for the third iteration of the objective function (favoring exploration over exploitation) and may have determined a loss value lower than −2. Having still not found a parameter that satisfies the one or more stopping criteria such as a loss sufficiently near zero (e.g., an acceptable range between −0.25 and 0.25) and having gained additional information from the previous guess, the acquisition function may have taken a more educated guess of x=3.5. The results of the FEA simulation for the parameter at x=3.5 is a loss value very near zero as indicated by point 418. At this point, the optimization loop 108 may determine that one or more stopping criteria has been met based on the loss being sufficiently close to zero (e.g., within an acceptable range) indicating that the desired expansion force may be met with an appliance having a thickness of 3.5.

Although the discussion above describes optimizing a single design parameter (depicted along a single x-axis), optimization could be applied across a plurality of design parameters (which may each be depicted along n axes in an n-dimensional space) that may be independent or dependent on each other. For example, each of these parameters could be mapped on a numerical continuum such that different numbers on the continuum represent different parameter values. Similarly, the loss value may be based on a plurality of desired characteristics. For example, the loss value may be a description of deviations from a plurality of ideal characteristics of a dental appliance, such as forces (e.g., expansionary force in a palatal expander, tooth movement forces in an aligner), durability, subject comfort, etc.

As discussed herein, when the one or more stopping criteria has been met as determined by block 112, the process may proceed to block 116.

While the disclosure focuses on Bayesian optimization using FEA simulation as the objective function, other types of optimization and other types of parameters, targets, probers, optimizers, and types of simulations (FEA and others) may be used within an optimization loop 108. For example, finite element analysis may be performed using one or more platforms such as Altair OpenRadioss, Radioss, Abaqus, and others. The finite element model used in the FEA simulation may use shell elements, beam elements, solid elements, etc. As discussed herein, the models of the dental appliances may be segmented devices, such as a palatal expander with multiple bands (as explained previously, the multiple bands may have gradual transition regions in between such that the final appliance is a continuous device; alternatively, the final appliance may have discrete segments that are apparent); or may be a non-segmented appliance defined by a single but not uniform thickness (e.g., defined by an average thickness); or a non-segmented appliance defined by a single, uniform thickness.

In some embodiments, other parameters and targets may be used in the optimization loop 108, for example, additional or different parameters as well as additional targets to the objective function in one optimization workflow. Additional design parameters may include buccal and crown thicknesses as well as transition region parameters. Transitions may be from palatal to crown regions and from crown to buccal regions, as shown and described with respect to FIGS. 5A, 5B, and 5C. As discussed herein, additional targets may include device insertion force being less than a specified maximum insertion force and the device removal force being within a range between a minimum removal force and a maximum removal force.

In some embodiments, the process 100 may include multiple optimization loops that operate in parallel or in serial. For example, after optimization loop 108 has determined thicknesses for the palatal expander in the palatal region, a second optimization loop 108 will be run holding the thickness parameters constant while evaluating buccal thickness parameters as those relate to dental appliance removal forces. Similarly, a third optimization loop 108 may run in parallel with the second optimization loop 108 to optimize other parameters of a dental appliance.

In some embodiments, the optimization, rather than being based on a thickness parameter of a band, may be based on other optimization processes. For example, the optimization may be a topology optimization, to optimize material distribution through the addition and/or removal of elements and nodes of a mesh that defines the dental appliance given a design space, boundary conditions, and targets. For example, a topology optimization may include a solid isotropic material utilizing a penalization method and a gradient-based optimization such as optimality criteria or method of moving asymptotes to update the elemental densities. By using topology optimization, the palatal expander structure within palatal region may obtain a free form shape that reduces material and achieves the desired expansion forces.

In some embodiments, a shape optimization may be used to generate a dental appliance geometry. A shape optimization may constrain the dental appliance to a particular topological layout. For example, holes or new surfaces of the appliance may not be generated, but the shape, for example, the nodal position that define the shape of the dental appliance may be moved or otherwise be optimized to satisfy one or more targets. In shape optimization, the internal and/or external boundaries of the dental appliance may be manipulated to optimize the appliance. For a palatal expander, the external boundary (such as the boundary that faces away from the palate may be optimized to achieve the desired expansion forces without changes to the material distribution

In some embodiments, size optimization may be used. In size optimization the dental appliance may be constrained to a particular shape and the size of specific components of the dental appliance is optimized. For example, for a palatal expander, the device contour would remain the same shape, matching the contour of the palate and dentition, but the nodal thickness map, such as for a shell element model of the appliance, may be optimized to achieve the desired forces or other targets.

Topology, shape, and size optimization approaches may be similar to the Bayesian optimization described herein. For example, each of topology, shape, or size optimization approach may uses a finite element method to probe, using a prober, device performance and the design may be optimized, using an optimizer, with gradient-based or non-gradient-based optimization algorithms.

In some embodiments, a differentiable simulation may be used as a replacement for the FEA simulation in the prober. A differentiable simulation may use computational models where the simulation process is made differentiable with respect to its inputs. In a differentiable simulation the output of the simulation can be adjusted by modifying the input parameters, and the impact of these adjustments on the output can be directly calculated using techniques from calculus, such as derivatives. This allows for the direct application of gradient-based optimization methods, which may replace the Bayesian optimizer in optimization loop 108. This approach leverages the power of automatic differentiation, enabling the efficient computation of gradients of the output with respect to design parameters, such as the dental appliance design parameters discussed herein. These gradients can then be used in optimization algorithms, typically leveraging gradient descent, to find optimal configurations or to train machine learning models that interact with or mimic the simulation. For example, PyTorch geometry can be used to provide gradient information relating the appliance geometry to nodes, and sensitivity analysis using the adjoint method can give closed-form expressions giving gradient information based on the nodes to generate an expected expansion force. For a palatal expander, optimization may include adjusting segment thicknesses to achieve a desired expansion force. Using differentiable simulation the gradients of the reaction forces with respect to these thicknesses may be directly calculated, leading to faster convergence and more efficient exploration of the design space than non-gradient-based optimization methods. In this way, palatal expander or other appliance performance may be evaluated by the differentiable simulations and optimized using gradient-based methods including gradient descent, stochastic gradient descent, Adam, and/or AdamW.

In some embodiments, a physics-informed neural network (PINN) may be used as a replacement for the FEA simulation in the prober. A physics-informed neural network may use deep learning to solve the governing partial differential equations of physical phenomena and simultaneously satisfy the given training data. A physics-informed neural network may provide gradient information for the physical system that is not available from finite element analysis, allowing for the use of gradient-based methods for optimization. In some embodiments, a physics-informed pointnet (PIPN) may be used. A physics-informed pointnet allows for the solution of governing equations on multiple computational domains with irregular geometries simultaneously. Work in relation to this disclosure has shown that PIPN may be effective for modeling linear elasticity. The performance of a dental appliance may be evaluated by the PINN or PIPN by the differentiable simulations and optimized using gradient-based methods including gradient descent, stochastic gradient descent, Adam, and/or AdamW.

In some embodiments, a graph neural network (GNN) may be used in place of a finite element analysis simulation. A graph neural network designed to process data represented in graph form. A GNN may be trained with data generated from FEA simulations wherein the inputs may be parameters, such as palatal expander band thicknesses and the outputs may be the targets, such as the total force applied by the palatal expander and the forces of each individual band. Other appliances, parameters, and targets may also be used. A trained GNN may be used in place of the FEA simulation to estimate the outcome of an FEA simulation based on the input design parameters, such as the segmental thicknesses of a palatal expander. Once trained, this GNN model may be used in place of the FEA simulation as a fast and efficient surrogate to the computationally expensive FEA simulations, enabling rapid exploration and optimization of the design space using a prober described herein.

In some embodiments, a genetic algorithm may be used as an optimizer. A genetic algorithm may mimic natural evolutionary processes to explore the design space, offering robustness and the ability to escape local optima by combining, mutating, and selecting design parameters across generations. A genetic algorithm is an alternative to Bayesian Optimization for optimizing designs, such as the palatal expander segmental thicknesses, such as when gradient information is not available. In some embodiments, a genetic algorithm may begin with a set of one or more values, such as 100 or 1000, for the parameters for use in designing a dental appliance. Each set is then checked, such as through a FEA simulation or one of its replacement discussed herein. Each set is evaluated for its fitness, such as with a fitness function, which may be a loss function, to score each set in the population. After scoring, a selection process is used to select the best results based on the score. Selected sets may be paired and combined and then mutated to generate a new generation of sets of parameters. After which the process repeats until the one or more stopping criteria are met.

At block 116 the optimized design parameters from the optimization loop may be output. In some embodiments, the output parameters may be the set of parameters that resulted in the least loss from amount all the iteration performed by the optimization loop 108. In some embodiments, the selected parameters may be the parameters used in the final iteration of the optimization loop, for example, without regard to the loss. In some embodiments, the convergence check may take place after selecting new parameters. In such embodiments, the updated parameters may be used.

In some embodiments, the optimization process 100 may be carried out for each stage of treatment, or for at least a plurality of the stages of treatment. In such embodiments, optimized design parameters may be output for each stage of treatment. In some embodiments, the parameters for unoptimized stages may be determined based on the optimized stages. For example, the parameters may be interpolated between two optimized stages to generate parameters for unoptimized stages. In some embodiments, the parameters may be extrapolated from one or more stages, such as at least two or at least three optimized stages. In some embodiments, the optimization process 100 may be carried out for less than all of the stages of treatment. For example, the process may be carried out for every odd stage of treatment. The design parameters for two sequential odd stages (such as a first stage and a third stage) may be interpolated, such as linearly or quadratically interpolated, to generate a set of parameters for an intervening even stage of treatment (such as a second stage). If the optimization process is carried out for every third, fourth, or fifth stage, then the parameters for the intervening two, three, or four stages may be determined based on the optimized stages, such as by using interpolation, including linear interpolation.

At block 118 the final shape of the dental appliance is generated based on the parameters provided in block 116. In some embodiments, the optimized parameters, along with other data, such as the 3D model of the patient's anatomy may be used to generate the appliance geometry.

The appliance may then be fabricated based on the final shape. In some embodiments, the appliance may be directly fabricated. In some embodiments, a mold may be generated and then fabricated based on the final appliance geometry. The appliance may then be fabricated using the mold.

FIG. 2 illustrates an appliance design 200 whose parameters may be simplified such as by defining a thickness for each of three bands, a band 202, a band 204, and a band 206. As can be seen in FIG. 2, bands 202, 204, and 206 may have similar or equal widths (e.g., equidistant) which may, in some examples, be equivalent to or more robust slicing than aligning with the patient's anatomy (e.g., by aligning with certain teeth and/or tooth features such as first primary molar, first permanent molar, etc.). This equidistant slicing may also approximate tooth-based balancing without requiring identifying and aligning teeth. In some embodiments, the bands may be separated based on the patient's anatomy. For example, a palatal expander may engage with three teeth on the right side of the patient's arch and three teeth on the left side of the patient's arch. For example, in some embodiments, appliance 200 may engage with the patient's left and right first permanent premolar, second permanent premolar, and the first permanent molar. In some embodiments, although the bands may be discretized in the design process, the final manufactured palatal expander may be continuous such that there are no discrete bands (e.g., there may be gradual transitions between each of the bands). In other embodiments, the manufactured palatal expander may exhibit discrete bands that may be observable.

In some embodiments, the bands may be defined by the location of the left and right teeth. For example, a first band may extend between the left and right first permanent premolar, a second band may extend between the left and right second permanent premolar, with the dividing line between the first and second band being at an interproximal location between the left first and second premolar and the right first and second premolar, and a third band may extend between the second premolar and the first molar with the dividing line between the left second premolar and the first molar and the right second molar with the first molar. In some embodiments, a palatal expander may extend between the left and right first permanent molars, second primary molars, and the first primary molars.

Although FIG. 2 illustrates 3 bands, in other examples, fewer or more bands may be used. In some embodiments, the parameters of the bands define one or more physical characteristics of the bands. For example, a thickness of the band may be an average thickness of the band or a thickness of the band at a centerline. In some embodiments, the thickness of a band may vary in a mesial distal direction to smoothly transition from a thickness of one band to a thickness of an adjacent band. In some embodiments, the thickness may be a linear interpolation between the center of one band to the center of an adjacent band.

FIG. 3 illustrates a model 300 of a portion of a dental appliance, such as a palatal expander designed and/or tested according to the systems and methods describe herein. For example, model 300 shows a finite element mesh 302, which may correspond to a finite element model used in the FEA described herein, and may be used to produce force calculations used in determining a target thickness for one or more portions of an appliance, such as bands of a palatal expander, based on inputs, such as target force, anatomical parameters, and material properties. As illustrated in FIG. 3, thickness values 306 may correspond to dimension values of a band, such as palatal depth parameters.

In some embodiments, parameters may include material properties of the dental appliance, such as the Young's Modulus and Poisson's Raito, which may be used in determining forces exerted by an appliance on a patient's dentition and the geometry and other structural and physical characteristics of the appliance, as described herein.

A dental appliance may have one or more parameters that aid in defining its characteristics. In some embodiments, the parameters may be the crown-to-crown distance 310, which may be measured across the patient's arch or the distance between crown center to crown center at the center 324 of a band 300, a respective tooth on the left and right side of the patient's arch. In some embodiments, the band's width 314 may be a parameter, which may be measured in a mesial-distal direction from a mesial side of a band to a distal side of the band. In some embodiments, the parameters may include the thickness of the palatal region (a region of the palatal expanded that corresponds to a patient's palate when worn) at the center 324 of the palatal region and the thicknesses 320, 322 of the palatal region at locations 1/3 of the distance 310 between the center 324 of the palatal region (which may correspond to the center of the palate when the palatal expander is worn by the subject) and a respective center of a left or right tooth receiving cavity (which may correspond to a respective crown center when worn by the subject), measured at either ⅓ the distance away from the center or ⅓ of the distance away from the center of the tooth receiving cavity.

The appliance may include a handle 301 that extends buccally from the tooth receiving cavities of the appliance. The handle provides a structure, not participating in the treatment, such as not shaped to reposition teeth, for a subject to grip or apply force to in order to remove the appliance from the patient's arch. The handle 301 may be located above the gingival line of the appliance and of the patient, when worn.

FIGS. 5A, 5B, and 5C illustrate diagrams of exemplary 2D representations 500, 501, and 502, respectively of a tooth 505 and reference features for determining and locating thickness values for a dental appliance, such as a palatal expander, aligner, retainer, mouthguard, etc. In some embodiments, the 2D representations may be extrapolated into 3D, for example along an arch. In some embodiments, the 2D representations may each correspond to a slice of a 3D image and/or model of the patient's dentition and orthodontic appliance.

The optimizations discussed herein, such as with respect to FIG. 1, may be used to optimize the thicknesses of other aspects of a dental appliance, such as the regions of a dental appliance including the tooth crowns, such as tooth receiving cavities, as depicted in and described with respect to FIGS. 5A-5C.

As illustrated in FIGS. 5A-5C, exemplary 2D representations 500, 501, and 502, respectively, of a tooth 505 and reference features for determining thickness values for a dental appliance, such as a palatal expander, a palatal expander and aligner combination, an aligner, a retainer, a mouthguard, etc. The reference features may include a crown center 512 and an axis point 510, among other locations discussed herein. Crown center 512 may correspond to a center point of a tooth, such as a center based on dimensions, geometric centroid of the crown, and/or another center of a tooth or crown as may be determined from a model of the tooth 505 or the crown. Axis point 510 may correspond to an offset from crown center 512, such as an offset based on a parameter, such as a crown axis distance parameter. The crown axis distance parameter may be in a range of 3 mm to 10 mm, 6 mm to 8 mm, or about 7 mm. Additional points and/or angles based on rays originating from axis point 510 may be calculated from axis point 510. For example, ridge points, which may correspond to crown ridges, may be determined based on the farthest point of the crown from axis point 510 on the respective lingual and buccal ridges of the crown cross-section.

In some embodiments, 2D representations 500, 501, and 502 may include a lingual ridge angle 532 with respect to axis point 510 used to define a lingual ridge point 530. Lingual ridge point 530 may correspond to a ridge point in the lingual direction or on a lingual side of the tooth 505. Lingual ridge point 530 may be defined as location on the crown furthest from the axis point 510 along the ray 531. The angle of the ray 531 from axis point 510 may be with respect to a reference axis 514 that is perpendicular to a ray 517 formed by crown center 512 and axis point 510. The furthest point along the ray may be defined by the location of an intersection of a line perpendicular to the ray with the crown furthest from the axis point 510.

In some embodiments, 2D representations 500, 501, and 502 may also include a buccal ridge point 540 defining a buccal ridge angle 542 with respect to axis point 510. Buccal ridge point 540 may correspond to a ridge point in the buccal direction or on a buccal side of the tooth 505. Buccal ridge angle 542 may be defined as an angle based on a ray 541 from axis point 510 to buccal ridge point 540 with respect to reference axis 514. In some embodiments, the angles 532 and 542 may be between 0.2π and 0.47π, more preferably between about 0.33π and 0.45π. In some embodiments, the angle 532 may be 0.33π and the angle 542 may be 0.45π.

The thickness values of a dental appliance may be divided into thickness zones having a defined thickness profile based on the zones, such as a center thickness zone 554, a crown thickness zone 558, and a buccal thickness zone 560, as illustrated in FIG. 5C.

The thickness parameters of each of the thickness zones may be optimized using the process described herein. In some embodiments, the thicknesses of one or more zones may be optimized for one or more different values of stopping criteria. For example, the thickness parameter of the center thickness zone 554, which may connect to a palatal region of a palatal expander, may be optimized for retention on the tooth under the palatal expansion forces, such that the lingual side of the tooth receiving cavity is able to retain the dental appliance (e.g., palatal expander, aligner) on the tooth during use. The retention may be at optimized to be high enough to retain the appliance. A stopping criteria may be a minimum retention force. Such an optimization may aid in preventing inadvertent disengagement of a dental appliance during use.

The thickness of the buccal thickness zone 560, which is located on a buccal side of a tooth crown, may be optimized for removal force, such as the force to remove the dental appliance from the subject's tooth. The buccal side retention may be optimized to be less than a maximum amount of retention and a stopping criteria may include the maximum amount of retention. Such an optimization may aid in allowing removal of the dental appliance for eating and drinking.

The thickness parameter of the crown thickness zone 558, which may be located on an occlusal portion of the subject's teeth, between the central zone and the buccal zone, may be optimized for both removal force and retention force. One or more stopping criteria of the crown thickness zone 558 may be related to a removal force and/or a retention force.

In some embodiments, the thickness of the zones may be optimized for other parameters, such as an orthodontic movement force or tooth displacement, as discussed herein.

Transition zones between the thickness zones may gradually change thickness from a first end (e.g., a first thickness zone) to a second end (e.g., a second thickness zone) such as by interpolating the thickness from the thickness of one zone to the thickness of an adjacent zone over the transition zone therebetween. For example, FIG. 5C illustrates a center-to- crown transitional zone 556 for transitioning between center thickness zone 554 and crown thickness zone 558, and a crown-to-buccal transitional zone 562 for transitioning between crown thickness zone 558 and buccal thickness zone 560.

Center-to-crown transitional zone 556 may be defined as extending between a lingual transition angle 522 and lingual ridge angle 532, as shown in FIG. 5C. Lingual transition angle 522 may be defined by a ray from axis point 510 to lingual transition point 520 with respect to reference axis 514. FIG. 5B illustrates how lingual transition point 520 may be determined based on a band thickness 550. Band thickness 550 may initially be uniformly applied along the crown edge (e.g., extending in a normal direction from the crown surface). A lingual transition height 552, which may be a parameter such as between about 0.5 mm and 4 mm, between about 1 mm and 3 mm, or about 2 mm, may be offset from lingual ridge point 530 in a direction parallel to a line between the crown center and the axis point 510. Reference line 553 may be a line parallel to axis 514 and/or perpendicular to line 517. In some embodiments, the lingual transition height point 524 may be at an intersection of line 553 and the location of the outer surface 551, which may indicate the location of the outer surface of a dental appliance. A ray from axis point 510 to lingual transition height point 524 may establish lingual transition angle 522 with respect to reference axis 514. Lingual transition point 520 may be defined as a point along the ray from axis point 510 to lingual transition height point 524 that intersects with the crown surface.

Crown-to-buccal transitional zone 562 may be defined by a buccal transition start ray 544 and a buccal transition ray 546, which may each correspond to predefined parameter values and may offset from a ray 547 defined by angle 545. The offset may be between 5 and 30 degrees. In some embodiments, the ray 544 may be offset from the ray 547 by an amount greater than the offset of ray 546. In some embodiments, the offset of ray 544 is 20 degrees and the offset of ray 546 may be 10 degrees. Thus, as illustrated in FIG. 5C, thickness values may transition from center thickness 554 to center-to-crown transitional zone 556, further transition to crown thickness 558 to crown-to-buccal transitional zone 562, and finally to buccal thickness 560, based on angles with respect to axis point 510. The center thickness 554 for each band may be different, based on the determined thickness, discussed herein. The center thickness 554 for band 202, the mesial band, may be in a range of between 0.5 mm and 5.0 mm, preferably between 1.0 mm and 3.5 mm. The center thickness 554 for band 204, the center band, may be in a range of between 0.5 mm and 6.0 mm, preferably between 1.0 mm and 5.5 mm, more preferably in a range of between 2.0 mm and 4.5 mm. The center thickness 554 for band 206, the distal band may be in a range of between 0.5 mm and 6.0 mm, preferably between 1.0 mm and 5.5 mm, more preferably in a range of between 2.0 mm and 4.5 mm. The buccal thickness 560 may be between 0.25 and 1.5 mm, preferably between 0.5 mm and 1.0 mm and most preferably, about 0.75 mm. The crown thickness 558 may be between 0.25 and 2.5 mm, preferably between 1.0 mm and 2.0 mm and most preferably, about 1.5 mm.

In some examples, 2D representations 500, 501, and 502 may be extrapolated into a 3D representation by establishing analogous points (e.g., axis point 510, lingual transition point 520, lingual ridge point 530, and buccal ridge point 540) for each crown or each crown cross section in each of the bands of the dental appliance, and establishing respective continuous curves along the arch for the analogous points. Thickness values may be extrapolated across these curves similar to the thickness values derived from the points as described above.

FIG. 6 illustrates an auxiliary positioner 600 comprising a plurality of registration elements 610 separated by a plurality of couplings 620. The registration elements 610 define an inner surface 612 that is configured to contact an occlusal surface of a tooth. An auxiliary positioner is a template that may be used to position one or more auxiliaries (e.g., attachments, buttons, power arms, or a combination thereof) in predetermined positions on a patient's teeth.

The auxiliary positioner 600 may also include an auxiliary frame 660 and one or more struts 604 that extend from the auxiliary frame 660 to hold an auxiliary 602 at a predetermined position relative to the registration element. The struts 604 may be positioned and shaped to support the auxiliary during fabrication, such as with a direct fabrication manufacturing process, such as SLA, and may also be positioned and shaped to allow the auxiliary 640 to decouple or otherwise separate from the auxiliary positioner 600 at the appropriate time during treatment. In some embodiments, the auxiliary frame 660 comprises a strut 604 that is configured to release the auxiliary 602 after the auxiliary 602 has been secured in place to a tooth.

In some embodiments, the auxiliary frame 660 extends from the registration element 610 on a portion of the buccal surface of a tooth. The auxiliary frame 660 may be provided on each registration element 610, or only on some registration elements 610. In some embodiments, one or more auxiliary frames 660 cover a portion of a lingual surface of a tooth, and auxiliary 602 may be bonded to the lingual tooth surface.

In some embodiments, an auxiliary positioner 600 includes one or more retention supports 650 that may be configured to engage the interproximal region of the dentition, the lingual surface of the tooth, an undercut region of select teeth, or a combination. In some embodiments, the retention support 650 is configured to elastically deform as it is placed on a dentition and thus provide a lingual force (that biases the auxiliary frame 660 in a lingual direction and thus positions the auxiliary support against the buccal surface of the tooth. Alternatively or in combination, the auxiliary frame 660 can urge the retention surface of the retention element 650 toward the tooth so as to position and orient the retention element on the tooth. A plurality of retention supports may be provided with an auxiliary positioner 600 and configured to cooperate to maintain the auxiliary positioner 600 secured to the dentition of a subject without the treatment professional holding it in place.

In some embodiments, the auxiliary positioner 600 is fabricated to fit a particular patient's teeth, and as such, can be specialized to provide an individual fit which may include the size and shape of the auxiliary 602, and other specialized characteristics.

In some embodiments, a computing device can be used to create a treatment plan to move the teeth of a subject in an incremental manner to improve their position within the patient's mouth, for example with one or more auxiliaries placed on one or more teeth of the patient. Other dental appliances can be created to aid subjects with sleep apnea or medication delivery, among other types of appliances.

A computing device can be used to create such devices or molds to fabricate such dental appliances, auxiliaries, and/or auxiliary positioners. In some embodiments, a computing device can be used to virtually model a patient's dentition along with dental appliances, auxiliaries, and/or auxiliary positioners.

In some embodiments, the shape and structure of an auxiliary positioner 600 may be designed for fabrication and use. For example, the auxiliary positioner 600 may include an auxiliary frame 660 and one or more struts 604 that hold an auxiliary (e.g., an attachment, button, power arm) in place during fabrication. The struts 604 may be designed to be easily separated from the auxiliary 602 after the auxiliary 602 has been placed on a patient's dentition. Parameters for designing an auxiliary frame and the struts for holding the auxiliary may include parameters for the geometry of the struts and their location. For example, the parameters may include the number of struts 604, their location such as their angular location about the auxiliary, the length of the struts 604, the diameter of the strut or parameters related to the cross-sectional area of the strut where the strut contacts the auxiliary. The parameters may also include the thickness of the frame 660 and a distance of the frame from the auxiliary, and other geometric parameters.

The parameters may be optimized for fabrication time (e.g., some structures may take longer to fabricate than others) more material removal, such as in subtractive manufacturing, takes longer to remove than a process that removes less material. In additive manufacturing adding more material takes longer to fabricate than a process that adds more material. Parameters for optimization may also include the support during fabrication and/or removability of an auxiliary from the struts that attach it to the auxiliary positioner. While many struts may provide ample support during handling and fabrication, they may lead to difficulty during removal, and too few struts may simplify removal, they may not provide proper support for accurate fabrication and may allow for unwanted movement or deformation during handling and placement of the auxiliary.

In some embodiments, parameters related to the size, shape, location, surface angle, and other features of an auxiliary (e.g., attachment, button) may be optimized for insertion force, retention force, and removal force.

In some embodiments, such as for an attachment, the attachment position and orientation may be determined using the optimizations methods describe above. The parameters of position and orientation may be optimized for an acceptable force or range of force or forces imparted on a tooth by the interaction of the attachment with an aligner for a stage of treatment. In some embodiments, the parameters of position and orientation may be optimized for an expected tooth displacement or displacement range of tooth displacement (e.g., translation or rotation) of a tooth for a stage of treatment. In some embodiments, a retention force of the attachment with an aligner may be optimized.

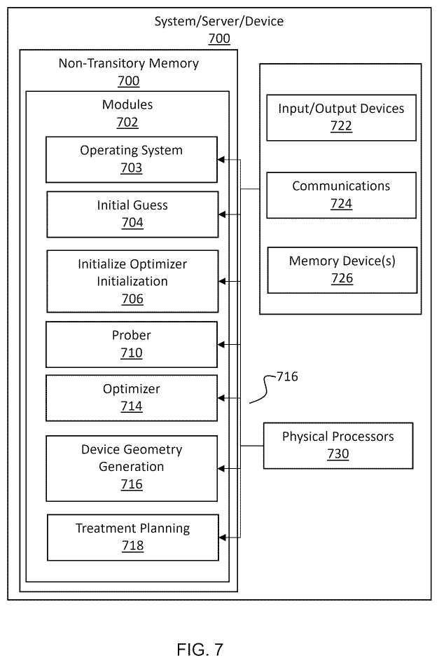

FIG. 7 is a diagram illustrating elements or components that may be present in a computer device or system configured to implement a method, process, function, or operation in accordance with an embodiment of the system and methods disclosed herein. As noted, in some embodiments, the system and methods may be implemented in the form of an apparatus that includes a processing element and set of executable instructions. The executable instructions may be part of a software application and arranged into a software architecture.

In general, an embodiment may be implemented using a set of software instructions that are designed to be executed by a suitably programmed processing element (such as a GPU, CPU, TPU, QPU, microprocessor, processor, co-processor, or controller, as non-limiting examples). In a complex application or system such instructions are typically arranged into “modules” with each such module typically performing a specific task, process, function, or operation. The entire set of modules may be controlled or coordinated in their operation by an operating system (OS) or other form of organizational platform.

Each application module or sub-module may correspond to a particular function, method, process, or operation that is implemented by the module or sub-module. Such function, method, process, or operation may include those used to implement one or more aspects of the disclosed and/or described systems, apparatuses, and methods.

The application modules and/or sub-modules may include a suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language.

The modules may contain one or more sets of instructions for performing a method, operation, or function described with reference to the Figures, and the disclosure and descriptions of the functions and operations provided herein. These modules may include those illustrated but may also include a greater number or fewer number than those illustrated. As mentioned, each module may contain a set of computer-executable instructions. The set of instructions may be executed by a programmed processor contained in a server, client device, network element, system, platform, or other component.

A module or sub-module may contain instructions that are executed by a processor contained in more than one of a server, client device, network element, system, platform, or other component. Thus, in some embodiments, a plurality of electronic processors, with each being part of a separate device, server, or system may be responsible for executing all or a portion of the software instructions contained in an illustrated module or sub-module. Thus, although FIG. 2 illustrates a set of modules which taken together perform multiple functions or operations, these functions or operations may be performed by different devices or system elements, with certain of the modules/sub-modules (or instructions contained in those modules/sub-modules) being associated with those devices or system elements.

As shown in FIG. 7, system 700 may represent a server or other form of computing or data processing system, platform, or device. Modules (or sub-modules) 702 each contain a set of executable instructions, where when the set of instructions is executed by a suitable electronic processor or processors (such as that indicated in the figure by “Physical Processor(s) 730”), system (or server, platform, or device) 700 operates to perform a specific process, operation, function, or method.

Modules 702 are stored in a (non-transitory) memory device 726, which typically includes an Operating System module 703 that contains instructions used (among other functions) to access and control the execution of the instructions contained in other modules. The modules 702 stored in memory 726 are accessed for purposes of transferring data and executing instructions by use of a “bus” or communications line 716, which also serves to permit processor(s) 730 to communicate with the modules for purposes of accessing and executing a set of instructions. Bus or communications line 716 also permits processor(s) 730 to interact with other elements of system 700, such as input or output devices 722, communications elements 724 for exchanging data and information with devices external to system 700, and memory devices 726.

For example, Modules 702 may contain computer-executable instructions which when executed by a programmed processor cause the processor or a device in which it is implemented to perform the following processes, methods, functions, or operations.

Module 704 may generate an initial guess for the parameter or set of parameters. For example, in some embodiments, a Bayesian optimization algorithm may be used. In such embodiments, the algorithm is initialized with an objective function that quantifies how well the dental appliance meets the desired specifications. For a palatal expander, the specifications may be the total amount of expansion force imparted on the patent's teeth along with the amount of expansion force imparted by each of three palatal expander bands.

In some embodiments, the objective function may be directed to other desired specifications or functionality. For example, with a palatal expander and an orthodontic aligner, insertion, retention, and removal force may be a design consideration. In some embodiments, the shape of the dental appliance at locations where the dental appliance interfaces with the patient's dentition, such as in a tooth receiving cavities, may be modified or optimized for in order to design and fabricate an aligner with sufficient ability to be retained on the patient's dentition while still allowing for easy insertion and removal of the appliance from the patient's teeth by the patient. In some embodiments, parameters that may have an effect on insertion, removal, and retention may include the thickness of the appliance at the tooth receiving cavity or near a tooth receiving portion of the appliance, and how closely the appliance fits the patient's anatomy such as the teeth when worn. For example, a parameter that defines the gap or distance between a tooth receiving cavity or other tooth engaging structure and the tooth may change the insertion force, removal force, and retention force. In some embodiments, parameters related to the size, shape, location, surface angle, and other features of a dental auxiliary may be optimized for insertion force, retention force, and removal force.

In some embodiments, the shape and structure of a dental appliance may be designed for fabrication and use. For example, an auxiliary positioner may include an auxiliary frame and one or more struts that hold the auxiliary in place during fabrication and then should be easily separated from the auxiliary after the auxiliary has been placed on a patient's dentition. Parameters for designing an auxiliary frame and the struts for holding the auxiliary may include parameters for the geometry of the struts and their location. For example, the parameters may include the number of struts, their location such as their angular location about the auxiliary, the length of the struts, the diameter of the struts or parameters related to the cross-sectional area of the strut where the strut contacts the auxiliary. The parameters may also include the thickness of the frame and a distance of the frame from the auxiliary, and other geometric parameters.

In some embodiments, optimization for fabrication may also include optimizing the geometry to control deflection of the device and layer adhesion during fabrication. For example, the placement and geometry of the device may be manipulated during optimization to control anticipated deflection during fabrication or one or more layers to within a range and below a threshold. Layer adhesion may be controlled based on, for example, the rate of change of cross sectional area from layer to layer during fabrication.

Each of these parameters may be initialized by the module 704.

Module 706 may initialize the optimizer, such as the optimizer within the optimization module 714. For example, in some embodiments, a Bayesian optimization algorithm may be used. In such embodiments, the algorithm is initialized with an objective function that quantifies how well the dental appliance meets the desired specifications. For a palatal expander, the specifications may be the total amount of expansion force imparted on the patent's teeth along with the amount of expansion force imparted by each of three palatal expander bands.

In some embodiments, the objective function may be directed to other desired specifications or functionality. For example, with a palatal expander and an orthodontic aligner, insertion, retention, and removal force may be a design consideration. In some embodiments, the shape of the dental appliance at locations where the dental appliance interfaces with the patient's dentition, such as in a tooth receiving cavities, may be modified or optimized for in order to design and fabricate an aligner with sufficient ability to be retained on the patient's dentition while still allowing for easy insertion and removal of the appliance from the patient's teeth by the patient. In some embodiments, parameters that may have an effect on insertion, removal, and retention may include the thickness of the appliance at the tooth receiving cavity or near a tooth receiving portion of the appliance, and how closely the appliance fix the patient's anatomy such as the teeth when worn. For example, a parameter that defines the gap or distance between a tooth receiving cavity or other tooth engaging structure and the tooth may change the insertion force, removal force, and retention force. In some embodiments, parameters related to the size, shape, location, surface angle, and other features of a dental auxiliary may be optimized for insertion force, retention force, and removal force.

Module 710 may evaluate an objective function with the parameters. In embodiments where in the loop 108 is a Bayesian optimization loop, the objective function is evaluated using the finite element simulation that predicts the dental appliances performance using the parameters as input. The finite element simulation may include aspects of the case model input such as the geometry of the patient's dental structures including the teeth (such as the crown and roots), palate, the gingiva, and other hard and soft tissues of the patient's intraoral cavity. The finite element simulation may also include in appliance design such as that received in the case model input, which may be modified based on the parameters received from the initial guess module.

The finite element analysis simulation may predict the dental appliances performance based on one or more boundary conditions. The boundary conditions may define the interaction between the dental appliance and the patient's dental anatomy.

The objective function may compute a loss by considering one or more constraints on the dental appliance's performance. The loss being, for example, a deviation of the evaluated result from the desired result.

For a palatal expander the targets may be a total force target and an individual force target. The total force target may be the sum of the reaction forces on the palatal expander from each of the teeth as compared to a predetermined target for the total force. The individual force target may be deviation of the value of each of the reaction forces on each tooth from a target value. In some embodiments the target value for the force on each tooth may be the same.

In some embodiments other targets may be used, such as those directed to other desired specifications or functionality. For example, with a palatal expander and an orthodontic aligner, insertion, retention, and removal force may be a target. In some embodiments, targets may include the insertion, removal, and retention forces of the appliance at the tooth receiving cavity or near a tooth receiving portion of the appliance. For example, a parameter that defines the gap or distance between a tooth receiving cavity or other tooth engaging structure and the tooth may change the insertion force, removal force, and retention force. In some embodiments, parameters related to the size, shape, location, surface angle, and other features of a dental auxiliary may be optimized for insertion force, retention force, and removal force.

In some embodiments, the support structures of an auxiliary positioner, such as shown and described with respect to FIG. 6 may be optimized. For example, the number, locations, size, and/or angle of the struts may be parameters that are optimized for the printability or mechanical supporting strength they provide, which may be quantized and optimized with using the optimization loop to obtain optimal design.

Module 714 may implement an optimizer, such as described with respect to FIG. 1. The optimizer may select new parameters for evaluating the objective function (such as by the prober module 710. In embodiments where in the loop 108 is a Bayesian optimization loop, a surrogate model, which may be a surrogate model of the objective function, may be updated with the results from the FEA simulation carried out for example by module 710, refining the model for the next iteration of optimization. New design parameters, such as the thickness for the three bands for a palatal expander or other parameters as described herein for other dental appliances, are selected by maximizing an acquisition function, which directs the search for the next point to evaluate. The acquisition function of module 714 may explore the design space to guess which values to use for each parameter for each iteration of the loop 108. As explained previously herein, the acquisition function may use strategies of exploitation and exploration in combination to intelligently guess values for evaluation by the objective function.

While the Bayesian has been discussed above, other types of optimizers may be used, for example as described with respect to FIG. 1.

Module 716 may generate the final shape of the dental appliance based on the parameters from the optimizer module 714, such as described with respect to FIG. 1. In some embodiments, module 716 may use the optimized parameters, along with other data, such as the 3D model of the patient's anatomy to generate the appliance geometry. The module 716 may output the geometry for fabrication or to cause a fabrication machine to fabricate the appliance based on the geometry. In some embodiments, the appliance may be directly fabricated. In some embodiments, a mold may be generated and then fabricated based on the final appliance geometry. The appliance may then be fabricated using the mold.

Module 718 may generate a dental treatment plan, as discussed herein. The module 718 may determine the stages of and generate an orthodontic treatment plan for moving a patient's teeth or other oral anatomy from an initial position, for example, based in part on the scan data of the patient's intraoral cavity, to a final position through a series of incremental movement stages. For an orthodontic treatment, the stages may move the teeth from an initial arrangement towards a desired final arrangement. For a palatal expanding treatment, the stages may widen the palate (and in doing do move the patient's teeth) from an initial configuration towards a final desired configuration. The module 718 may provide for image viewing and manipulation such that rendered images may be scrollable, pivotable, zoomable, and interactive.

As mentioned, in some embodiments, the systems and methods disclosed and/or described herein may provide services through a Software-as-a-Service (SaaS) or multi- tenant platform. The platform provides access to multiple entities, each with a separate account and associated data storage. Each account may correspond to a dentist or orthodontist, a patient, an entity, a set or category of entities, a set or category of patients, an insurance company, or an organization, for example. Each account may access one or more services, a set of which are instantiated in their account, and which implement one or more of the methods or functions disclosed and/or described herein.

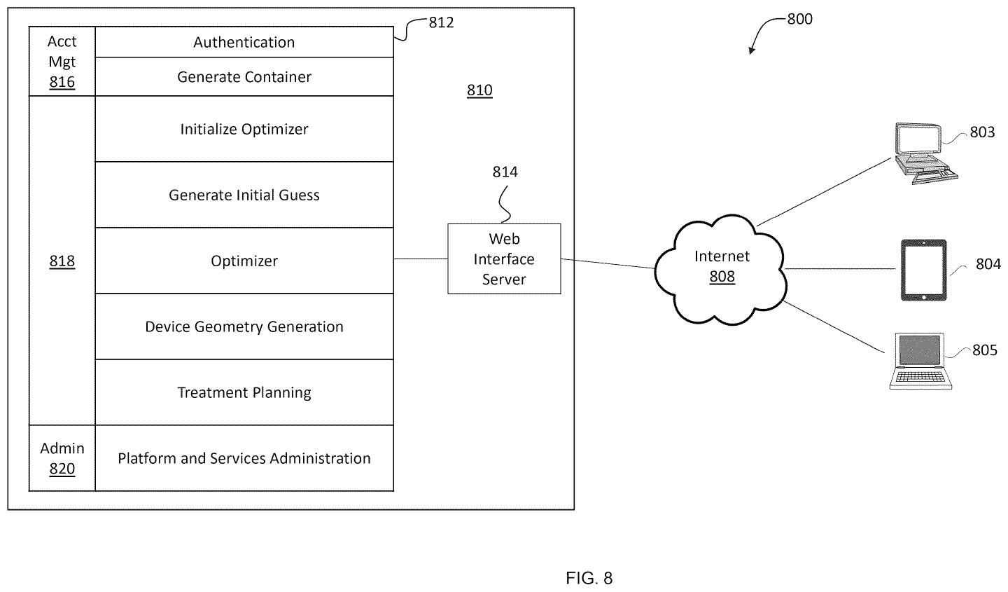

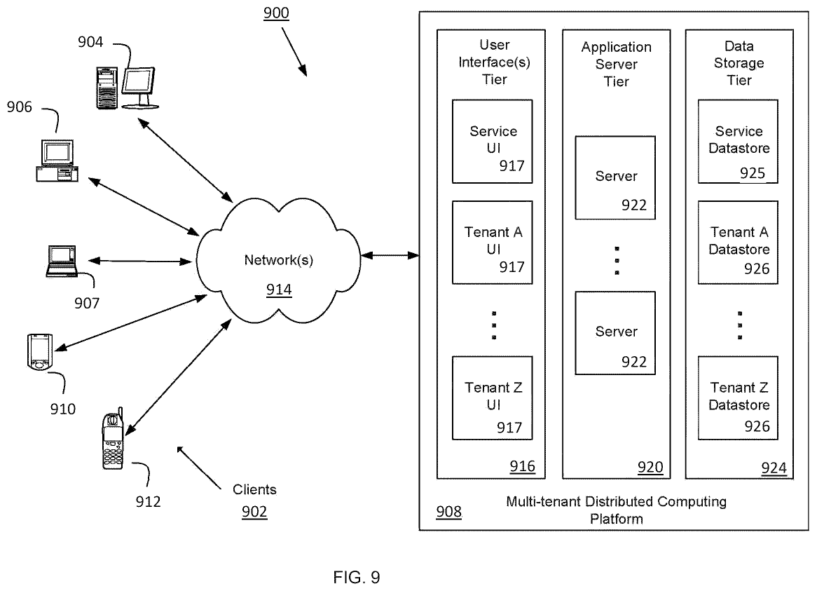

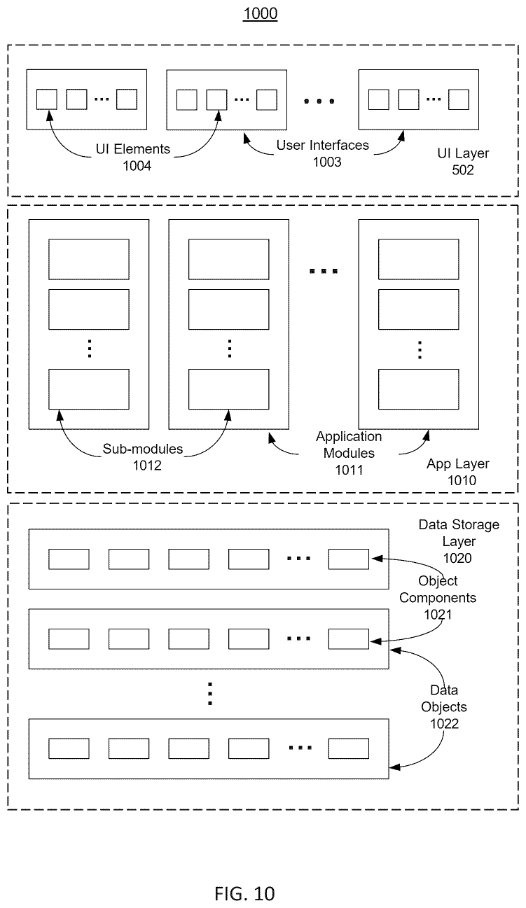

FIG. 8 is a diagram illustrating a SaaS system in which an embodiment of the disclosure may be implemented. FIG. 9 is a diagram illustrating elements or components of an example operating environment in which an embodiment of the disclosure may be implemented. FIG. 10 is a diagram illustrating additional details of the elements or components of the multi-tenant distributed computing service platform of FIG. 9, in which an embodiment of the disclosure may be implemented.

In some embodiments, the system or service(s) disclosed and/or described herein may be implemented as micro-services, processes, workflows, or functions performed in response to requests. The micro-services, processes, workflows, or functions may be performed by a server, data processing element, platform, or system. In some embodiments, the services may be provided by a service platform located “in the cloud”. In such embodiments, the platform is accessible through APIs and SDKs.

The described document processing and evaluation services may be provided as micro-services within the platform for each of multiple users or companies. The interfaces to the micro-services may be defined by REST and GraphQL endpoints. An administrative console may allow users or an administrator to securely access the underlying request and response data, manage accounts and access, and in some cases, modify the processing workflow or configuration.

Note that although FIGS. 8-10 may illustrate a multi-tenant or SaaS architecture that may be used for the delivery of business-related or other applications and services to multiple accounts/users, such an architecture may also be used to deliver other types of data processing services and provide access to other applications. For example, such an architecture may be used to provide the document processing and evaluation processes disclosed and/or described herein.

Although in some embodiments, a platform or system of the type illustrated in FIGS. 8-10 may be operated by a 3rd party provider, in other embodiments, the platform may be operated by a provider and a different source may provide the applications or services for users through the platform.

FIG. 8 is a diagram illustrating a system 800 in which an embodiment of the disclosure may be implemented or through which an embodiment of the services disclosed and/or described herein may be accessed. In accordance with the advantages of an application service provider (ASP) hosted business service system (such as a multi-tenant data processing platform), users of the services may comprise individuals, businesses, stores, or organizations, as non-limiting examples. A user may access the services using a suitable client, including but not limited to desktop computers, laptop computers, tablet computers, scanners, or smartphones. In general, a client device having access to the Internet may be used to provide a request or text message requesting a service (such as the processing of a document). Users interface with the service platform across the Internet 808 or another suitable communications network or combination of networks. Non-limiting examples of suitable client devices include desktop computers 803, smartphones 804, tablet computers 805, or laptop computers 806.

System 810, which may be hosted by a third party, may include a set of services 812 and a web interface server 814, coupled as shown in FIG. 8. It is to be appreciated that either or both of services 812 and the web interface server 814 may be implemented on one or more different hardware systems and components, even though represented as singular units in FIG. 8.

In some embodiments, the set of applications or services available to a user may include one or more that perform the functions and methods disclosed and/or described herein.

In some embodiments, the set of applications, functions, operations, or services made available through the platform or system 810 may include account management services 316 that may include a process or service to authenticate a person or entity requesting data processing services (such as credentials, proof of purchase, or verification that the customer has been authorized by a company to use the services provided by the platform). In some embodiments, the account management services 316 that may include a process or service to receive a request for processing of a set of images or video;

In some embodiments, the account management services 316 that may include a process or service to generate a price for the requested service or a charge against a service contract.

In some embodiments, the account management services 316 that may include a process or service to generate a container or instantiation of the requested processes for a user/customer, where the instantiation may be customized for a particular company, and other forms of account management services.

In some embodiments, the set of applications, functions, operations, or services made available through the platform or system 810 may include a set of processes or services 818, such as, for example, to provide or receive a case model input, to initialize an optimizer, to generate an initial guess for one or more parameters, to iterate an optimization loop, to evaluate an objective function with a prober using the parameters and within an optimization loop, to evaluate one or more stopping criteria within an optimization loop, to select new parameters using an optimizer within an optimization loop, to output optimized design parameters based on the results of the optimization loop, and to generate a finalized device.

In some embodiments, the set of applications, functions, operations, or services made available through the platform or system 810 may include administrative services 820, such as a process or services to enable the provider of the data processing and services and/or the platform to administer and configure the processes and services provided to users.

The platform or system shown in FIG. 8 may be hosted on a distributed computing system made up of at least one, but typically multiple, “servers.” A server is a physical computer dedicated to providing data storage and an execution environment for one or more software applications or services intended to serve the needs of the users of other computers that are in data communication with the server, for instance via a public network such as the Internet. The server, and the services it provides, may be referred to as the “host” and the remote computers, and the software applications running on the remote computers being served may be referred to as “clients.” Depending on the computing service(s) that a server offers it could be referred to as a database server, data storage server, file server, mail server, print server, or web server (as examples).

FIG. 9 is a diagram illustrating elements or components of an example operating environment 900 in which an embodiment of the disclosure may be implemented. As shown, a variety of clients 902 incorporating and/or incorporated into a variety of computing devices may communicate with a multi-tenant service platform 908 through one or more networks 914. For example, a client may incorporate and/or be incorporated into a client application (e.g., software) implemented or executed at least in part by one or more of the computing devices. Examples of suitable computing devices include personal computers, server computers 904, desktop computers 906, laptop computers 907, notebook computers, tablet computers or personal digital assistants (PDAs) 910, smart phones 912, cell phones, and consumer electronic devices incorporating one or more computing device components (such as one or more electronic processors, microprocessors, central processing units (CPU), or controllers). Examples of suitable networks 914 include networks utilizing wired and/or wireless communication technologies and networks operating in accordance with any suitable networking and/or communication protocol (e.g., the Internet).

The distributed computing service/platform (which may also be referred to as a multi-tenant data processing platform) 908 may include multiple processing tiers, including a user interface tier 916, an application server tier 920, and a data storage tier 924. The user interface tier 916 may maintain multiple user interfaces 917, including graphical user interfaces and/or web-based interfaces. The user interfaces may include a default user interface for the service to provide access to applications and data for a user or “tenant” of the service (depicted as “Service UI” in the figure), as well as one or more user interfaces that have been specialized/customized in accordance with user specific requirements (e.g., represented by “Tenant A UI”, . . . , “Tenant Z UI” in the figure, and which may be accessed via one or more APIs).

The default user interface may include user interface components enabling a tenant to administer the tenant's access to and use of the functions and capabilities provided by the service platform. This may include accessing tenant data, launching an instantiation of a specific application, or causing the execution of specific data processing operations, as non-limiting examples. Each application server or processing tier 922 shown in the figure may be implemented with a set of computers and/or components including computer servers and processors, and may perform various functions, methods, processes, or operations as determined by the execution of a software application or set of instructions. The data storage tier 924 may include one or more data stores, which may include a Service Data store 925 and one or more Tenant Data stores 926. Data stores may be implemented with a suitable data storage technology, including structured query language (SQL) based relational database management systems (RDBMS).

Service Platform 908 may be multi-tenant and may be operated by an entity to provide multiple tenants with a set of business-related or other data processing applications, data storage, and functionality. For example, the applications and functionality may include providing web-based access to the functionality used by a business to provide services to end-users, thereby allowing a user with a browser and an Internet or intranet connection to view, enter, process, or modify certain types of information. Such functions or applications are typically implemented by one or more modules of software code/instructions that are maintained on and executed by one or more servers 922 that are part of the platform's Application Server Tier 920. As noted with regards to FIG. 8, the platform system shown in FIG. 4 may be hosted on a distributed computing system made up of at least one, but typically multiple, “servers.”

As mentioned, rather than build and maintain such a platform or system themselves, a business may utilize a platform or system provided by a third party. A third party may implement a business system/platform as described in the context of a multi-tenant platform, where individual instantiations of a business' data processing workflow (such as the image processing and uses disclosed and/or described herein) are provided to users, with each company/business representing a tenant of the platform. One advantage to such multi-tenant platforms is the ability for each tenant to customize their instantiation of the data processing workflow to that tenant's specific business needs or operational methods. Further, each tenant may be a business or entity that uses the multi-tenant platform to provide business services and functionality to multiple users.

FIG. 10 is a diagram illustrating additional details of the elements or components of the multi-tenant distributed computing service platform of FIG. 9, in which an embodiment of the disclosure may be implemented. In general, an embodiment may be implemented using a set of software instructions that are designed to be executed by a suitably programmed processing element (such as a CPU, microprocessor, processor, controller, or computing device). In a complex system such instructions are typically arranged into “modules” with each such module performing a specific task, process, function, or operation. The entire set of modules may be controlled or coordinated in their operation by an operating system (OS) or other form of organizational platform.

The example architecture 1000 of a multi-tenant distributed computing service platform illustrated in FIG. 5 includes a user interface layer or tier 1002 having one or more user interfaces 1003. Examples of such user interfaces include graphical user interfaces and application programming interfaces (APIs). Each user interface may include one or more interface elements 1004. For example, users may interact with interface elements to access functionality and/or data provided by application and/or data storage layers of the example architecture. Examples of graphical user interface elements include buttons, menus, checkboxes, drop-down lists, scrollbars, sliders, spinners, text boxes, icons, labels, progress bars, status bars, toolbars, windows, hyperlinks, and dialog boxes. Application programming interfaces may be local or remote and may include interface elements such as parameterized procedure calls, programmatic objects, and messaging protocols.

The application layer 1010 may include one or more application modules 1011, each having one or more associated sub-modules 1012. Each application module 1011 or sub-module 1012 may correspond to a function, method, process, or operation that is implemented by the module or sub-module (e.g., a function or process related to providing data processing and other services to a user of the platform). Such function, method, process, or operation may include those used to implement one or more aspects of the disclosed system and methods, such as for one or more of the processes, operations, or functions disclosed and/or described herein. For example, to provide or receive a case model input, to initialize an optimizer, to generate an initial guess for one or more parameters, to iterate an optimization loop, to evaluate an objective function with a prober using the parameters and within an optimization loop, to evaluate one or more stopping criteria within an optimization loop, to select new parameters using an optimizer within an optimization loop, to output optimized design parameters based on the results of the optimization loop, and to generate a finalized device.

The application modules and/or sub-modules may include any suitable computer- executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language. Each application server (e.g., as represented by element 922 of FIG. 9) may include each application module. Alternatively, different application servers may include different sets of application modules. Such sets may be disjoint or overlapping.

The data storage layer 1020 may include one or more data objects 1022 each having one or more data object components 1021, such as attributes and/or behaviors. For example, the data objects may correspond to tables of a relational database, and the data object components may correspond to columns or fields of such tables. Alternatively, or in addition, the data objects may correspond to data records having fields and associated services. Alternatively, or in addition, the data objects may correspond to persistent instances of programmatic data objects, such as structures and classes. Each data store in the data storage layer may include each data object. Alternatively, different data stores may include different sets of data objects. Such sets may be disjoint or overlapping.

Note that the example computing environments depicted in FIGS. 8-10 are not intended to be limiting examples. Further environments in which an embodiment may be implemented in whole or in part include devices (including mobile devices), software applications, systems, apparatuses, networks, SaaS platforms, IaaS (infrastructure-as-a- service) platforms, or other configurable components that may be used by multiple users for data entry, data processing, application execution, or data review (as non-limiting examples).

FIG. 11 depicts a simplified block diagram of a data processing system 1100 that may be used in executing methods and processes described herein. The data processing system 1100 typically includes at least one processor 1102 that communicates with one or more peripheral devices via bus subsystem 1104. These peripheral devices typically include a storage subsystem 1106 (memory subsystem 1108 and file storage subsystem 1114), a set of user interface input and output devices 1118, and an interface to outside networks 1116. This interface is shown schematically as “Network Interface” block 1116, and is coupled to corresponding interface devices in other data processing systems via communication network interface 1124. Data processing system 1100 can include, for example, one or more computers, such as a personal computer, workstation, mainframe, laptop, and the like.

The user interface input devices 1118 are not limited to any particular device, and can typically include, for example, a keyboard, pointing device, mouse, scanner, interactive displays, touchpad, joysticks, etc. Similarly, various user interface output devices can be employed in a system of the invention, and can include, for example, one or more of a printer, display (e.g., visual, non-visual) system/subsystem, controller, projection device, audio output, and the like.

Storage subsystem 1106 maintains the basic required programming, including computer readable media having instructions (e.g., operating instructions, etc.), and data constructs. The program modules discussed herein are typically stored in storage subsystem 1106. Storage subsystem 1106 typically includes memory subsystem 1108 and file storage subsystem 1114. Memory subsystem 1108 typically includes a number of memories (e.g., RAM 1110, ROM 1112, etc.) including computer readable memory for storage of fixed instructions, instructions and data during program execution, basic input/output system, etc. File storage subsystem 1114 provides persistent (non-volatile) storage for program and data files, and can include one or more removable or fixed drives or media, hard disk, floppy disk, CD-ROM, DVD, optical drives, and the like. One or more of the storage systems, drives, etc. may be located at a remote location, such coupled via a server on a network or via the internet/World Wide Web. In this context, the term “bus subsystem” is used generically so as to include any mechanism for letting the various components and subsystems communicate with each other as intended and can include a variety of suitable components/systems that would be known or recognized as suitable for use therein. It will be recognized that various components of the system can be, but need not necessarily be at the same physical location, but could be connected via various local-area or wide-area network media, transmission systems, etc.

Dental scanning system 1120 includes any means for obtaining a digital representation (e.g., images, surface topography data, subsurface data etc.) of a patient's anatomy (e.g., by scanning physical models of the teeth such as casts 1121, by scanning impressions taken of the teeth, or by directly scanning the intraoral cavity, and by other means, as described herein), which can be obtained either from the patient or from treating professional, such as an orthodontist, and includes means of providing the digital representation to data processing system 1100 for further processing. Dental scanning system 1120 may be located at a location remote with respect to other components of the system and can communicate image data and/or information to data processing system 1100, for example, via a network interface 1124. Fabrication system 1122 fabricates appliances 1123 based on a treatment plan, including data set information received from data processing system 1100. Fabrication machine 1122 can, for example, be located at a remote location and receive data set information from data processing system 1100 via network interface 1124.

Embodiments as disclosed and/or described herein can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

The disclosure includes the following clauses and embodiments:

Clause 1. A method of designing a personalized dental appliance, the method comprising: receiving a digital anatomical model an intraoral cavity of a patient; selecting a test parameter set for a test dental appliance, the test parameter set defining one or more design parameters of the test dental appliance; performing an optimization process for identifying a final design parameter set, wherein the optimization process comprises: (a) initializing a surrogate model representing an uncertainty distribution of design parameters and values associated with effects corresponding to the design parameters; (b) simulating, using an evaluator, one or more effects of the test dental appliance based on the test parameter set; (c) determining whether the simulated effects satisfy one or more predetermined criteria for the personalized dental appliance; (d) updating the surrogate model based on the simulated effects; and (e) selecting, with an optimizer, a subsequent test parameter set; determining, based on the optimization process, the final design parameter set; and generating a digital model of the dental appliance based on the final design parameter set.

Clause 2. The method of clause 1, further comprising receiving initial design parameters for a non-personalized dental appliance, and wherein the one or more test parameter sets are selected based on the initial design parameters.

Clause 3. The method of clause 1, wherein the test parameter set is selected by a machine learning model that has been trained on a library of annotated virtual dental appliances.

Clause 4. The method of clause 1, wherein the test parameter set is selected by: identifying a plurality of candidate parameter sets for the personalized dental appliance, each candidate parameter set defining one or more design parameters of a respective virtual dental appliance; evaluating each of the candidate parameter sets using a trained machine learning model; and selecting, from the candidate parameters, the test parameter set based on the evaluation.

Clause 5. The method of clause 3 or 4, wherein training the machine learning model includes: gathering data associated with previously dental appliances, patient anatomy, and resulting forces, training the machine learning model to generate appliance parameters that generate the desired resulting forces based on the patient anatomy.

Clause 6. The method of clause 1, further comprising repeating steps (b) to (e) until the simulated effects are determined to satisfy the predetermined criteria.

Clause 7. The method of clause 1, wherein the surrogate function is a Gaussian function.

Clause 8. The method of clause 7, wherein the evaluator is a finite element analysis simulation.

Clause 9. The method of clause 8, wherein the finite element analysis simulation simulates the forces imparted by the test dental appliance on the digital anatomical model.

Clause 10. The method of clause 1, wherein: the design parameters include one or more thicknesses of the dental appliance at one or more locations.

Clause 11. The method of clause 10, wherein: the one or more locations are one or more areas and the one or more thicknesses are one or more average thickness over a respective one of the one or more areas.

Clause 12. The method of clause 1, wherein: the evaluator comprises a finite element model of the dental appliance based on the digital model of the dental appliance applied to the digital anatomical model of the intraoral cavity of the patient.

Clause 13. The method of clause 12, wherein: simulating, using an evaluator, includes simulating application of the dental appliance on the intraoral cavity of the subject with the finite element model.

Clause 14. The method of clause 1, wherein: the optimizer comprises an acquisition function that selects the subsequent test parameter set.

Clause 15. The method of clause 1, wherein: wherein determining whether the one or more simulated effects satisfy one or more predetermined criteria for the personalized dental appliance includes evaluating a loss function that compares the one or more simulated effects to the one or more predetermined criteria.

Clause 16. The method of clause 1, wherein: the one or more simulated effects includes one or more forces applied by the dental appliance to tissue of the patient.

Clause 17. The method of clause 16, wherein: the dental appliance is a palatal expander and the one or more forces include a total expansion force applied by the palatal expander to the patient's tissue.

Clause 18. The method of clause 17, wherein: the one or more forces include a first, second, and third force applied by the palatal expander to a respective first, second, and third pairs of teeth of the patient's dentition.

Clause 19. The method of clause 18, wherein: wherein the model of the palatal expander includes a plurality of segments, each extending between a respective one of the first, second, and third pairs of teeth.

Clause 20. The method of clause 19, wherein a thickness of each of the segments is optimized to distribute the total expansion force across the first, second, and third pairs of teeth.

Clause 21. The method of clause 20, wherein the total expansion force is distributed within evenly, within a threshold, amongst the first, second, and third forces.

Clause 22. The method of clause 1, wherein: (c) may include comparing a loss value of the simulated effect with respect to the one or more predetermined criteria against a predefined loss value threshold.

Clause 23. The method of clause 22, wherein: the one or more predetermined criteria are met by the simulated effects when the loss value is below the loss value threshold.

Clause 24. The method of clause 1, wherein: the dental appliance is an auxiliary positioner and the test parameters include a quantity of struts to support an auxiliary and an orientation of each strut of the quantity of struts.

Clause 25. The method of clause 24, wherein: the simulated effects include the mechanical support strength of the quantity of struts and the releasably of the strut from the auxiliary.

Clause 26. The method of clause 1, wherein: the dental appliance is an orthodontic aligner or a palatal expander and the test parameters include a distance between one or more tooth engagement structures and a respective teeth.

Clause 27. The method of clause 26, wherein: the simulated effects include one or more of, insertion force, retention force, and removal force.

Clause 28. A system comprising: a processor, and memory comprising instructions that when executed by the processors cause the system to carry out the method of any one of the preceding clauses.

Clause 29. A non-transitory computer-readable medium comprising instructions that when executed by a processor cause the processor to carry out the method of any one of the proceeding clauses.

The software components, processes, or functions disclosed and/or described in this application may be implemented as software code to be executed by a processor using a suitable computer language such as Python, Java, JavaScript, C, C++, or Perl using conventional or object-oriented techniques. The software code may be stored as a series of instructions or commands in (or on) a non-transitory computer-readable medium, such as a random-access memory (RAM), a read only memory (ROM), a magnetic medium such as a hard-drive, or an optical medium such as a CD-ROM. In this context, a non-transitory computer-readable medium is a medium suitable for the storage of data or an instruction set aside from a transitory waveform. Such computer readable medium may reside on or within a single computational apparatus and may be present on or within different computational apparatuses within a system or network.

According to one example implementation, the term processing element or processor, as used herein, may be a central processing unit (CPU), or conceptualized as a CPU (such as a virtual machine). In this example implementation, the CPU or a device in which the CPU is incorporated may be coupled, connected, and/or in communication with one or more peripheral devices, such as a display. In another example implementation, the processing element or processor may be incorporated into a mobile computing device, such as a smartphone or tablet computer.

The non-transitory computer-readable storage medium referred to herein may include a number of physical drive units, such as a redundant array of independent disks (RAID), a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, synchronous dynamic random access memory (SDRAM), or similar devices or forms of memories based on similar technologies. Such computer-readable storage media allow the processing element or processor to access computer-executable process steps and application programs, stored on removable and non-removable memory media, to off-load data from a device or to upload data to a device. As mentioned, with regards to the embodiments disclosed and/or described herein, a non-transitory computer-readable medium may include a structure, technology, or method apart from a transitory waveform or similar medium.

Example embodiments of the disclosure are described herein with reference to block diagrams of systems, and/or flowcharts or flow diagrams of functions, operations, processes, or methods. One or more blocks of the block diagrams, or one or more stages or steps of the flowcharts or flow diagrams, and combinations of blocks in the block diagrams and combinations of stages or steps of the flowcharts or flow diagrams may be implemented by computer-executable program instructions. In some embodiments, one or more of the blocks, or stages or steps may not necessarily need to be performed in the order presented or may not necessarily need to be performed at all.

The computer-executable program instructions may be loaded onto a general-purpose computer, a special purpose computer, a processor, or other programmable data processing apparatus to produce a specific example of a machine. The instructions that are executed by the computer, processor, or other programmable data processing apparatus create means for implementing one or more of the functions, operations, processes, or methods disclosed and/or described herein. The computer program instructions may be stored in (or on) a computer-readable memory that may direct a computer or other programmable data processing apparatus to function in a specific manner, such that the instructions stored in (or on) the computer-readable memory produce an article of manufacture including instruction means that when executed implement one or more of the functions, operations, processes, or methods disclosed and/or described herein.

While embodiments of the disclosure have been described in connection with what is presently considered to be the most practical approach and technology, the embodiments are not limited to the disclosed implementations. Instead, the disclosed implementations are intended to include and cover modifications and equivalent arrangements included within the scope of the appended claims. Although specific terms are employed herein, they are used in a generic and descriptive sense only and not for purposes of limitation.

This written description uses examples to describe one or more embodiments of the disclosure, and to enable a person skilled in the art to practice the disclosed approach and technology, including making and using devices or systems and performing the associated methods. The patentable scope of the disclosure is defined by the claims, and may include other examples that occur to those skilled in the art. Such other examples are intended to be within the scope of the claims if they have structural and/or functional elements that do not differ from the literal language of the claims, or if they include structural and/or functional elements with insubstantial differences from the literal language of the claims.

All references, including publications, patent applications, and patents, cited herein are hereby incorporated by reference to the same extent as if each reference was individually and specifically indicated to be incorporated by reference and/or was set forth in its entirety herein.

The use of the terms “a” and “an” and “the” and similar references in the specification and in the claims are to be construed to cover both the singular and the plural, unless otherwise indicated herein or clearly contradicted by context. The terms “having,” “including,” “containing” and similar references in the specification and in the claims are to be construed as open-ended terms (e.g., meaning “including, but not limited to,”) unless otherwise noted.

Recitation of ranges of values herein are intended to serve as a shorthand method of referring individually to each separate value inclusively falling within the range, unless otherwise indicated herein, and each separate value is incorporated into the specification as if it were individually recited herein. Method steps or stages disclosed and/or described herein may be performed in any suitable order unless otherwise indicated herein or clearly contradicted by context.

The use of examples or exemplary language (e.g., “such as”) herein, is intended to illustrate embodiments of the disclosure and does not pose a limitation to the scope of the claims unless otherwise indicated. No language in the specification should be construed as indicating any non-claimed element as essential to each embodiment of the disclosure.

As used herein (i.e., the claims, figures, and specification), the term “or” is used inclusively to refer items in the alternative and in combination.

Different arrangements of the elements, structures, components, or steps illustrated in the figures or described herein, as well as components and steps not shown or described are possible. Similarly, some features and sub-combinations are useful and may be employed without reference to other features and sub-combinations. Embodiments have been described for illustrative and not for restrictive purposes, and alternative embodiments may become apparent to readers of the specification. Accordingly, the disclosure is not limited to the embodiments described in the specification or depicted in the figures, and modifications may be made without departing from the scope of the appended claims.

One or more embodiments of the disclosed subject matter are described herein with specificity to meet statutory requirements, but this description does not limit the scope of the claims. The claimed subject matter may be embodied in other ways, may include different elements or steps, and may be used in conjunction with other existing or later developed technologies. This description should not be interpreted as implying any required order or arrangement among or between various steps or elements except when the order of individual steps or arrangement of elements is explicitly noted as being required.

Embodiments of the disclosure will be described more fully herein with reference to the accompanying drawings, which form a part hereof, and which show, by way of illustration, exemplary embodiments by which the disclosure may be practiced. The disclosure may, however, be embodied in different forms and should not be construed as limited to the embodiments set forth herein; rather, these embodiments are provided so that this disclosure will satisfy the statutory requirements and convey the scope of the disclosure to those skilled in the art.

Among others, the subject matter of the disclosure may be embodied in whole or in part as a system, as one or more methods, or as one or more devices. Embodiments may take the form of a hardware implemented embodiment, a software implemented embodiment, or an embodiment combining software and hardware aspects. For example, in some embodiments, one or more of the operations, functions, processes, or methods described herein may be implemented by one or more suitable processing elements (such as a processor, microprocessor, co-processor, CPU, GPU, TPU, QPU, or controller, as non-limiting examples) that is part of a client device, server, network element, remote platform (such as a SaaS platform), an “in the cloud” service, or other form of computing or data processing system, device, or platform.

The processing element or elements may be programmed with a set of executable instructions (e.g., software instructions), where the instructions may be stored in (or on) one or more suitable non-transitory data storage elements. In some embodiments, the set of instructions may be conveyed to a user through a transfer of instructions or an application that executes a set of instructions (such as over a network, e.g., the Internet). In some embodiments, a set of instructions or an application may be utilized by an end-user through access to a SaaS platform or a service provided through such a platform.

In some embodiments, the systems and methods disclosed herein may provide

services through a SaaS or multi-tenant platform. The platform provides access to multiple entities, each with a separate account and associated data storage. Each account may correspond to a dentist or orthodontist, a patient, an entity, a set or category of entities, a set or category of patients, an insurance company, or an organization, for example. Each account may access one or more services, a set of which are instantiated in their account, and which implement one or more of the methods or functions disclosed and/or described herein.

In some embodiments, one or more of the operations, functions, processes, or methods described herein may be implemented by a specialized form of hardware, such as a programmable gate array, application specific integrated circuit (ASIC), or the like. Note that an embodiment of the inventive methods may be implemented in the form of an application, a sub-routine that is part of a larger application, a “plug-in”, an extension to the functionality of a data processing system or platform, or other suitable form. The following detailed description is, therefore, not to be taken in a limiting sense.

What is claimed is:

1. A system for designing a personalized dental appliance for a patient, the system comprising:
a processor, and
memory comprising instructions that when executed by the processor cause the system to carry out a method comprising:
receiving a digital anatomical model of an intraoral cavity of the patient;
selecting a test parameter set for a test dental appliance, the test parameter set defining one or more test design parameters of the test dental appliance;
performing an optimization process for identifying a final design parameter set, wherein the optimization process comprises:
(a) initializing a surrogate model representing an uncertainty distribution of the test design parameters and values associated with one or more effects corresponding to the test design parameters;
(b) simulating, using an evaluator, the one or more effects of the test dental appliance based on the test parameter set;
(c) determining whether the simulated one or more effects satisfy one or more predetermined criteria for the personalized dental appliance;
(d) updating the surrogate model based on the simulated one or more effects; and
(e) selecting, with an optimizer, a subsequent test parameter set;
determining, based on the optimization process, the final design parameter set; and
generating a digital model of the personalized dental appliance based on the final design parameter set.

2. The system of claim 1, wherein the test parameter set is selected by a machine learning model that has been trained on a library of annotated virtual dental appliances.

3. The system of claim 1, wherein the test parameter set is selected by:
identifying a plurality of candidate parameter sets for the personalized dental appliance, each candidate parameter set defining one or more design parameters of a respective virtual dental appliance;
evaluating each of the candidate parameter sets using a trained machine learning model; and
selecting, from the candidate parameter sets, the test parameter set based on the evaluation.

4. The system of claim 1, wherein the method further comprises repeating steps (b) to (e) until the simulated one or more effects are determined to satisfy the predetermined criteria.

5. The system of claim 1, wherein:
the test design parameters include one or more thicknesses of the test dental appliance at one or more locations.

6. The system of claim 5, wherein:
the one or more locations are one or more areas and the one or more thicknesses are one or more average thickness over a respective one of the one or more areas.

7. The system of claim 1, wherein:
the evaluator comprises a finite element model of the test dental appliance based on the digital model of the test dental appliance applied to the digital anatomical model of the intraoral cavity of the patient.

8. The system of claim 1, wherein:
the optimizer comprises an acquisition function that selects the subsequent test parameter set.

9. The system of claim 1, wherein:
wherein determining whether the simulated one or more effects satisfy one or more predetermined criteria for the personalized dental appliance includes evaluating a loss function that compares the simulated one or more effects to the one or more predetermined criteria.

10. The system of claim 1, wherein:
the simulated one or more effects include one or more forces applied by the test dental appliance to tissue of the patient.

11. The system of claim 10, wherein:
the test dental appliance is a palatal expander and the one or more forces include a total expansion force applied by the palatal expander to the tissue of the patient.

12. The system of claim 11, wherein:
the one or more forces include a first, second, and third force applied by the palatal expander to a respective first, second, and third sets of teeth.

13. The system of claim 12, wherein:
wherein test dental appliance includes a plurality of segments, each extending between a respective one of the first, second, and third sets of teeth.

14. The system of claim 13, wherein a thickness of each of the segments is configured to distribute the total expansion force across the first, second, and third sets of teeth.

15. The system of claim 14, wherein the total expansion force is distributed evenly, within a threshold, amongst the first, second, and third forces.

16. A method of designing a personalized dental appliance, the method comprising:
receiving a digital anatomical model an intraoral cavity of a patient;
selecting a test parameter set for a test dental appliance, the test parameter set defining one or more test design parameters of the test dental appliance;
performing an optimization process for identifying a final design parameter set, wherein the optimization process comprises:
(a) initializing a surrogate model representing an uncertainty distribution of the test design parameters and values associated with one or more effects corresponding to the test design parameters;
(b) simulating, using an evaluator, the one or more effects of the test dental appliance based on the test parameter set;
(c) determining whether the simulated one or more effects satisfy one or more predetermined criteria for the personalized dental appliance;
(d) updating the surrogate model based on the simulated one or more effects; and
(e) selecting, with an optimizer, a subsequent test parameter set;
determining, based on the optimization process, the final design parameter set; and
generating a digital model of the personalized dental appliance based on the final design parameter set.

17. The method of claim 16, further comprising fabricating the personalized dental appliance based on the digital model.

18. The method of claim 16, wherein the test parameter set is selected by:
identifying a plurality of candidate parameter sets for the personalized dental appliance, each candidate parameter set defining one or more design parameters of a respective virtual dental appliance;
evaluating each of the candidate parameter sets using a trained machine learning model; and
selecting, from the candidate parameter sets, the test design parameters for the test parameter set based on the evaluation.

19. The method of claim 1, wherein the evaluator comprises a finite element model of the test dental appliance based on the digital model of the test dental appliance applied to the digital anatomical model of the intraoral cavity of the patient.

20. A non-transitory computer-readable medium comprising instructions that when executed by a processor cause the processor to carry out a method for designing a personalized dental appliance for a patient comprising:
receiving a digital anatomical model of an intraoral cavity of the patient;
selecting a test parameter set for a test dental appliance, the test parameter set defining one or more test design parameters of the test dental appliance;
performing an optimization process for identifying a final design parameter set, wherein the optimization process comprises:
(a) initializing a surrogate model representing an uncertainty distribution of the test design parameters and values associated with one or more effects corresponding to the test design parameters;
(b) simulating, using an evaluator, the one or more effects of the test dental appliance based on the test parameter set;
(c) determining whether the simulated one or more effects satisfy one or more predetermined criteria for the personalized dental appliance;
(d) updating the surrogate model based on the simulated one or more effects; and
(e) selecting, with an optimizer, a subsequent test parameter set;
determining, based on the optimization process, the final design parameter set; and
generating a digital model of the personalized dental appliance based on the final design parameter set.
